(19) United States
(12) Patent Application Publication
(10) Pub. No.: US 2024/0350365 A1
(43) Pub. Date: Oct. 24, 2024

(54) DRUG INSPECTION APPARATUS AND DRUG INSPECTION METHOD

(71) Applicant: Hitachi Channel Solutions, Corp., Tokyo (JP)

(72) Inventors: Daisuke HOSOKAWA, Tokyo (JP); Riichi KATOU, Tokyo (JP); Makoto KATSUCHI, Tokyo (JP); Eiji MAKIMOTO, Tokyo (JP); Yoshiki HAYASHI, Tokyo (JP)

(73) Assignee: Hitachi Channel Solutions, Corp., Tokyo (JP)

(21) Appl. No.: 18/685,323

(22) PCT Filed: Aug. 10, 2022
(86) PCT No.: PCT/JP2022/030674

§ 371 Date: Feb. 21, 2024

(30) Foreign Application Priority Data
Aug. 31, 2021 (JP) 2021-141423

(51) Int. Cl. A61J 3/00; G06T 7/00

(52) U.S. Cl. CPC A61J 3/00; G06T 7/0004; A61J 2200/70; G06T 2207/30108

(57) ABSTRACT

The drug inspection apparatus includes: a pre-inspection storage portion that temporarily stores a drug group which is a plurality of drugs collectively charged, and spreads the individual drugs in an elongated and substantially one row; a transfer processing portion that transfers the spread drug group to a conveyance path; a conveyance inspection processing portion that conveys the drug group on the conveyance path, and has an inspection imaging portion that takes images of the drug group with a camera; a discharge processing portion that discharges the imaged drug group to a post-inspection storage portion; the post-inspection storage portion that temporarily stores the drug group, and then discharges the drug group to the outside of the apparatus; and an inspection control portion that executes, by software control, a control of operations of each portion, and an inspection process for the drug group, which uses the captured image.

### TECHNICAL FIELD

The present invention relates to a drug inspection apparatus and a drug inspection method, and is suitable for application to a drug inspection apparatus and a drug inspection method for inspecting dispensed drugs.

### DESCRIPTION OF THE RELATED ART

### Background Art

In hospitals and drugstores, drugs are dispensed according to prescriptions, and generally, a pharmacist performs a drug inspection for checking whether or not the amount of the prepared drug and the like are correct. In particular, when a plurality of drugs are combined and prescribed in one package for one dose, it is necessary to distribute the drugs and inspect the contents of the drugs, for each dose. Various methods have been proposed for automation technologies and efficiency technologies for supporting this work.

For example, in Patent Literature 1, there is disclosed a technology in which a drug is dropped onto a disk-shaped member for inspection, then, is rotated around a predetermined axial center, and is transported. Patent Literature 1 states “In the drug packaging apparatus of the present invention, the plurality of receiving portions are arranged in a circumferential direction on a rotating body which is configured to be rotatable around a predetermined axial center position, and it is preferable that the delivery portion can perform the delivery operation for the drug in the receiving portion which is arranged in a predetermined operation area. According to such a configuration, the drug packaging apparatus performs the delivery operation by moving the rotating body toward the inside of the operation area of the delivery portion while sequentially preparing the drugs which have been supplied from a drug preparing and dispensing portion side, in the plurality of receiving portions, and can successively supply the drugs to a pre-packaging imaging portion side. Thereby, the drug packaging apparatus can efficiently perform an operation of individually supplying the drugs one by one to the pre-packaging imaging portion side, in an individual supply portion.”

As a technology similar to Patent Literature 1, in Patent Literature 2, there is disclosed an inspection apparatus that moves solid drugs discharged from a hopper to a plurality of inspection containers arranged on an upper surface of a turntable for each dose, and moves the turntable to an imaging position at which a photographing apparatus for taking a picture of the solid drugs in the inspection containers takes a picture of the solid drugs.

In addition, Patent Literature 3 discloses a technology of an apparatus that supports an inspection of a drug after the drug has been packed into one package as one dose. Patent Literature 3 states “The apparatus illuminates a sachet in which a drug is enclosed between two films, from a side of one of the two films, in the state, takes an image of the sachet from a side of the other of the two films, and thereby acquires a transmitted light image that is an image of the sachet; illuminates the sachet from the side of the other film, in the state, takes an image of the sachet from the side of the other film, and thereby acquires a reflected light image which is a color image of the sachet; detects a drug area that indicates an area of the drug which is enclosed in the sachet and, with the use of the transmitted light image; and cuts out an image of the area of the reflected light image corresponding to the drug area, thereby creates a drug image which is a color image, and displays the drug image on a display portion.”

In addition, Patent Literature 4 is cited as a technology of using two cameras for taking a picture of drugs. Patent Literature 4 states “An image acquiring portion 20 includes: two cameras (imaging portions) 22A and 22B that take a picture of a drug; an illuminating portion 24 which has a plurality of light sources; and a photographing control portion 26 that controls the cameras 22A and 22B and the illuminating portion 24, as illustrated in FIG. 2.

### CITATION LIST

### Patent Literature

[Patent Literature 1] International Publication No. WO 2017-002713
[Patent Literature 2] International Publication No. WO 2013-105198
[Patent Literature 3] International Publication No. WO 2012-005004
[Patent Literature 4] International Publication No WO 2020-105395

### SUMMARY OF INVENTION

### Technical Problem

However, there has been such a problem in the drug dispensing apparatus described in Patent Literature 1 that a processing mechanism from the charge of the drug to be inspected to the discharge of the drug after the inspection is complicated, and it takes a time period to perform the inspection process for each dose. In addition, the imaging of the drug is performed one tablet by one tablet, and accordingly, it results in taking a longer time period when the number of drugs for one dose is large. In addition, there has been also such a problem that a processing time period is accumulated and becomes long for a plurality of consecutive prescriptions, and furthermore, the mechanism becomes complicated and large.

In addition, in the inspection apparatus (drug supply apparatus) disclosed in Patent Literature 2, such a situation has been assumed that in the case where a large number of drugs are contained in one dose, a plurality of drugs result in overlapping each other in an inspection container, and the drugs cannot be imaged and inspected with high accuracy. In such a situation, it is necessary to perform an imaging by the imaging portion, after the inspection container has been stopped, and accordingly there has been such a problem that the operation takes a time period. In addition, in Patent Literature 2, there has been such a problem that imaging process for inspecting each tablet from the captured image takes a time period.

In addition, in the apparatuses disclosed in Patent Literature 3 and Patent Literature 4, such a situation is assumed that in the case where a large number of drugs are contained in one dose, the drugs tend to easily become a state in which the drugs are unevenly distributed in a packaging sheet in which the drugs are packed into one package, and the drugs overlap each other and thereby the apparatuses cannot image and inspect the drugs with high accuracy. In addition, the imaging portion is not configured in consideration of such a situation that drugs for a large number of doses are continuously supplied, and there has been a problem also in a processing power.

The present invention has been made in view of the above points, and provides a drug inspection apparatus and a drug inspection method that take an image of a drug for one dose including a plurality of tablets, in a state in which each tablet is arranged to be easily identified in a state where the drug is not packed into one package, and can execute the inspection for a drug including a plurality of tablets with high accuracy.

### Solution to Problem

In order to solve the above problems, the present invention provides a drug inspection apparatus that inspects dispensed drugs, including: a pre-inspection storage portion that temporarily stores a drug group which is a plurality of drugs collectively charged, and spreads the individual drugs in an elongated and substantially one row; a transfer processing portion that transfers the drug group to a conveyance path while maintaining a spread state in the pre-inspection storage portion; a conveyance inspection processing portion that conveys the drug group transferred to the conveyance path at a predetermined speed, and also has an inspection imaging portion that takes images of individual drugs of the drug group on the conveyance path; a discharge processing portion that discharges the imaged drug group to a post-inspection storage portion; the post-inspection storage portion that temporarily stores the drug group discharged by the discharge processing portion, and then discharges the drug group to the outside of the apparatus; and an inspection control portion that executes, by software control, a control of operations of the pre-inspection storage portion, the transfer processing portion, the conveyance inspection processing portion, the discharge processing portion and the post-inspection storage portion, and an inspection process for the drug group, which uses a captured image by the inspection imaging portion, wherein the inspection control portion performs image identification of the captured image of the drug group by the inspection imaging portion with the use of master data of a plurality of types of drugs that have been registered in advance, in the inspection process for the drug group, thereby identifies the type and the number of the imaged individual drugs, inspects whether or not the identified content matches the constitution of the drugs shown in the prescription data of the drug group, and notifies an inspection result.

In addition, in order to solve the above problems, the present invention provides a drug inspection apparatus that inspects dispensed drugs, including: a pre-inspection storage portion that temporarily stores a drug group which is a plurality of drugs collectively charged, and spreads the individual drugs in an elongated and substantially one row; a transfer processing portion that transfers the drug group to a predetermined mounting plane while maintaining a spread state in the pre-inspection storage portion; an inspection imaging portion that takes images of individual drugs of the drug group, which are transferred to the predetermined mounting plane, by a camera movable above the predetermined mounting plane; a discharge processing portion that is arranged below the predetermined mounting plane, and discharges the drug group after having been imaged to a post-inspection storage portion from the predetermined mounting plane; a post-inspection storage portion that temporarily stores the drug group discharged by the discharge processing portion, and then discharges the drug group to the outside of the apparatus; and an inspection control portion that performs an inspection process on the drug group with the use of the captured image by the inspection imaging portion, wherein the pre-inspection storage portion forms a storage space for the drug group so that an inclined surface is V-shaped and a bottom surface is elongated, and causes the individual drugs of the drug group to be spread in an elongated short row and substantially in one row on the bottom surface, by vibrating a constituent member of the inclined surface; the predetermined mounting plane has a structure of being inclined downward and opening the front, and thereby dropping the drug group after the imaging to the discharge processing portion; and the inspection control portion performs image identification of the captured image of the drug group by the inspection imaging portion with the use of master data of a plurality of types of drugs that have been registered in advance, in the inspection process for the drug group, thereby identifies the type and the number of the imaged individual drugs, inspects whether or not the identified contents match the constitution of the drug shown in the prescription data of the drug group, and notifies an inspection result.

In addition, in order to solve the above problems, the present invention provides a drug inspection method by a drug inspection apparatus that inspects dispensed drugs, wherein the drug inspection apparatus includes: a pre-inspection storage portion that temporarily stores a drug group which is a plurality of drugs collectively charged, and spreads the individual drugs in an elongated and substantially one row; a transfer processing portion that transfers the drug group to a conveyance path while maintaining a spread state in the pre-inspection storage portion; a conveyance inspection processing portion that conveys the drug group transferred to the conveyance path at a predetermined speed and includes an inspection imaging portion that takes images of individual drugs of the drug group on the conveyance path; a discharge processing portion that discharges the imaged drug group to a post-inspection storage portion; the post-inspection storage portion that temporarily stores the drug group discharged by the discharge processing portion, and then discharges the drug group to the outside of the apparatus; and an inspection control portion that executes, by software control, a control of operations of the pre-inspection storage portion, the transfer processing portion, the conveyance inspection processing portion, the discharge processing portion and the post-inspection storage portion, and an inspection process for the drug group, which uses a captured image by the inspection imaging portion, wherein the inspection control portion performs image identification of the captured image of the drug group by the inspection imaging portion with the use of master data of a plurality of types of drugs that have been registered in advance, in the inspection process for the drug group, thereby identifies the type and the number of the imaged individual drugs, inspects whether or not the identified contents match the constitution of the drug shown in the prescription data of the drug group, and notifies an inspection result.

### Advantageous Effects of Invention

According to the present invention, it is possible to accurately execute the inspection for the drug including a plurality of tablets.

### BRIEF DESCRIPTION OF DRAWINGS

FIG. 1 is a view showing an example of a schematic configuration of a drug inspection apparatus 10 according to one embodiment of the present invention.

FIG. 2 is a view showing an example of a schematic configuration of a drug packaging apparatus 101 which mounts the drug inspection apparatus 10 therein.

FIG. 3 is a front view and a top view of a drug inspection apparatus 11 according to Example 1.

FIG. 4 is a block diagram showing an example of an internal configuration of the drug inspection apparatus 11, centering on an inspection control portion 800.

FIG. 5A is a configuration diagram (part 1) of a pre-inspection storage portion 200.

FIG. 5B is a configuration diagram (part 2) of the pre-inspection storage portion 200.

FIG. 5C is a configuration diagram (part 3) of the pre-inspection storage portion 200.

FIG. 5D is a configuration diagram (part 4) of the pre-inspection storage portion 200.

FIG. 6A is a configuration diagram (part 1) of a transfer processing portion 300.

FIG. 6B is a configuration diagram (part 2) of the transfer processing portion 300.

FIG. 6C is a configuration diagram (part 3) of the transfer processing portion 300.

FIG. 6D is a configuration diagram (part 4) of the transfer processing portion 300.

FIG. 6E is a configuration diagram (part 5) of the transfer processing portion 300.

FIG. 7 is a configuration diagram of a conveyance inspection processing portion 400, a discharge processing portion 600, and a post-inspection storage portion 700.

FIG. 8 is a flowchart showing an example of a processing procedure of a control process by a drug operation control portion 804.

FIG. 9 is a diagram showing an example of a process transition of an inspection process at the time when a plurality of drugs are continuously charged.

FIG. 10A is a configuration diagram (part 1) of an inspection imaging portion 500.

FIG. 10B is a configuration diagram (part 2) of the inspection imaging portion 500.

FIG. 11 is a schematic diagram for describing an imaging operation by an inspection imaging portion 500.

FIG. 12 is a diagram showing one example of an initial screen of inspection selection.

FIG. 13 is a diagram showing one example of an inspection process screen.

FIG. 14 is a diagram showing another example of the inspection process screen.

FIG. 15 is a diagram showing one example of an inspection correction screen.

FIG. 16A is a side view of a drug inspection apparatus 12 according to Example 2.

FIG. 16B is a front view of the drug inspection apparatus 12 according to Example 2.

FIG. 17A is a view (part 1) for describing an operation of drug inspection in the drug inspection apparatus 12.

FIG. 17B is a view (part 2) for describing the operation of the drug inspection in the drug inspection apparatus 12.

FIG. 17C is a view (part 3) for describing the operation of the drug inspection in the drug inspection apparatus 12.

FIG. 17D is a view (part 4) for describing the operation of the drug inspection in the drug inspection apparatus 12.

### DESCRIPTION OF EMBODIMENTS

An embodiment of the present invention will be described in detail below with reference to the drawings.

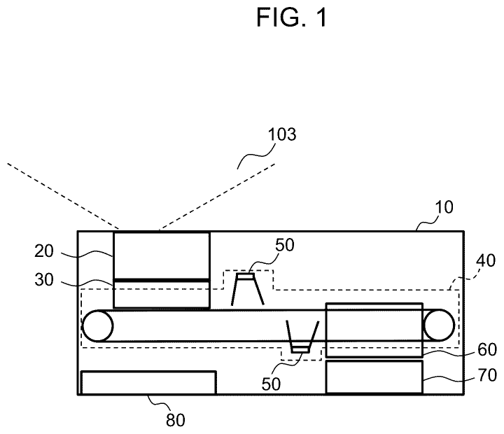

FIG. 1 is a view showing an example of a schematic configuration of a drug inspection apparatus 10 according to one embodiment of the present invention. The drug inspection apparatus 10 includes a pre-inspection storage portion 20, a transfer processing portion 30, a conveyance inspection processing portion 40 having an inspection imaging portion 50, a discharge processing portion 60, and a post-inspection storage portion 70; and each of these portions is continuously arranged as a configuration for forming a movement path of a plurality of drugs M which the drug inspection apparatus 10 receives. Furthermore, in addition to the above portions, the drug inspection apparatus 10 includes an inspection control portion 80 that controls and processes the movement, imaging and inspection of the drug M. The inspection control portion 80 is a component that realizes a predetermined function by software, in which hardware (for example, a processor, a storage element, various interfaces, and the like) constituting a computer performs execution of a predetermined program, storage of data, and the like, but may be a component in which hardware realizes a part or all of the functions.

When each drug in the plurality of drugs M to be received is represented by m, the drug inspection apparatus 10 performs individual inspection processes for each one drug group (referred to as drug M) in the inspection control process to determine whether or not each drug m contained in the drug group matches the drug information which has been registered in advance. The inspection processing result for the drug m is, for example, expressed as “normal” when it has been determined that the drug m matches the drug information, and is expressed as “uncertain” when it cannot be determined that the drug m matches the drug information.

The drug inspection apparatus 10 consolidates the inspection processing results for the above individual drugs m for each drug M, and performs the inspection process for the drug M including the plurality of drugs m which have been received. The inspection processing result for the drug M is expressed as “normal” when all the inspection processing results of the included drugs m are normal, and is expressed as “uncertain” when there is an uncertain inspection result for at least a part of the drugs m.

Furthermore, the drug inspection apparatus 10 can receive another drug M (hereinafter, referred to as M1, M2, M3 and so on) continuously to the drug M, and continuously performs the inspection process on the plurality of drugs M1, M2, M3 and so on. Then, the drug inspection apparatus 10 consolidates the inspection results of the drugs M1, M2, M3 and so on, which have been continuously handled, and outputs such a processing result that all the inspection results are “normal”, or at least some of the inspection results are “uncertain”. For information, in the present specification, “drugs M are continuously charged/another drug M is continuously received to the drug M” means that the charging period (or the receiving period) of a preceding drug group (for example, the drug M1) and the charging period (or the receiving period) of a subsequent drug group (for example, the drug M2) are executed continuously without overlapping their respective charging periods; and includes that a predetermined time period is interposed between the end of the charging (or reception) of the drug M1 and the start of the charging (or reception) of the drug M2 (in other words, the drugs M are intermittently and continuously charged (or received)).

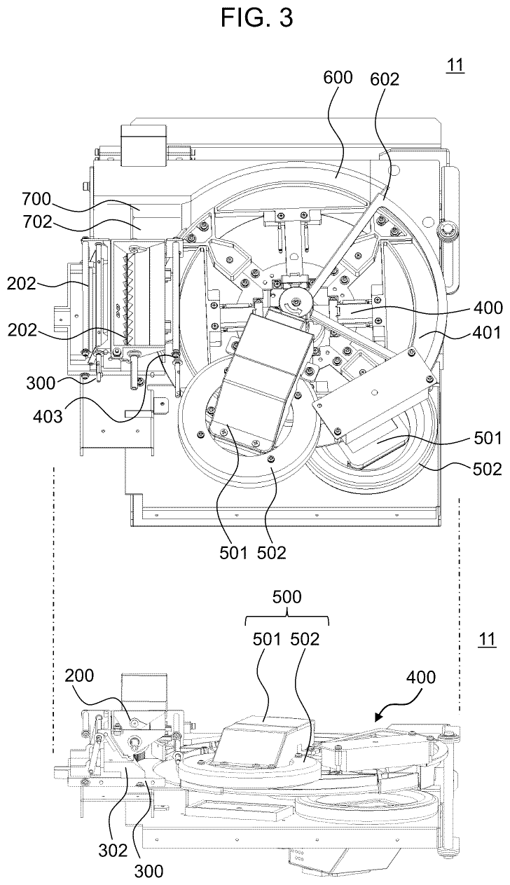

The flow of the drug M will be specifically described below. The plurality of drugs M which the drug inspection apparatus 10 receives are temporarily held in the pre-inspection storage portion 20. After that, the plurality of drugs m contained in each drug M sequentially fall to the transfer processing portion 30 of a subsequent stage, which is arranged on the lower side, with predetermined intervals for each drug M being spaced; and move. Furthermore, the conveyance inspection processing portion 40 in the subsequent stage uses a conveying means (which is, for example, a conveying belt in FIG. 1, a rotary disc in FIG. 3 which will be described later, or the like) which continuously operates in the horizontal direction, and thereby transfers the drug M (a plurality of drugs m) from the transfer processing portion 30 onto a conveying means. Here, at the subsequent stage on the conveying means, the inspection imaging portions 50 each including a camera and an illumination lamp are arranged above and below the conveying means, and the inspection imaging portions 50 take images of the drugs M which move on the conveying means, from the upper surface and the lower surface. Though details will be described later, the inspection process is executed on the individual drugs m constituting the drug M, with the use of the captured images. Then, in the discharge processing portion 60 which is arranged at the end point of the conveying means, the drug M is moved from the conveying means to the post-inspection storage portion 70, and when the inspection process for the drug M is finished, the drug is discharged from the post-inspection storage portion 70.

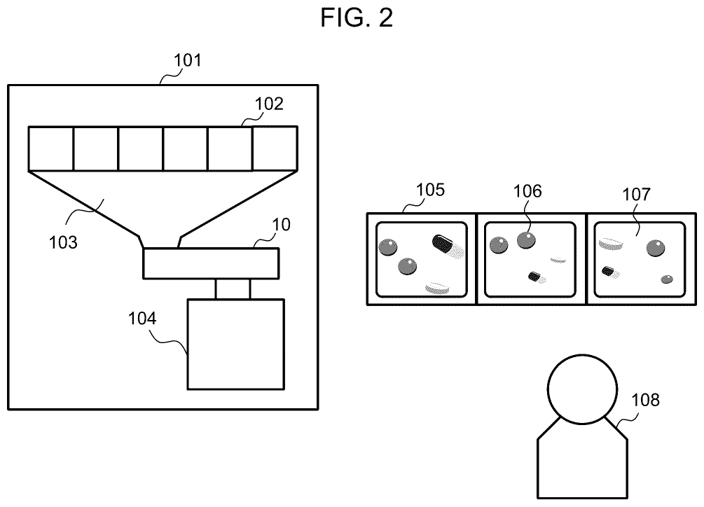

FIG. 2 is a view showing an example of a schematic configuration of a drug packaging apparatus 101 which mounts the drug inspection apparatus 10 therein. The drug packaging apparatus 101 is an apparatus for packaging a plurality of drugs (having the same meaning as the drug M) which have been instructed by a prescription from a doctor, in units of the drug M, and as shown in FIG. 2, includes a drug storage portion 102, a drug supply portion 103, the drug inspection apparatus 10, and a drug packaging portion 104. A pharmacist 108 takes out a drug (for example, a packaged drug 105) which has been packaged by the drug packaging portion 104 in the drug packaging apparatus 101, checks the contents, and delivers the drug to a patient. For example, in the packaged drug 105 shown in FIG. 2, a plurality of one package prescription drugs 107, each of which packs one or more individual drugs 106 prescribed as the amount of one dose in one bag, are connected to each other by the number of times of the dose to be given to the patient.

The configuration of the drug packaging apparatus 101 (the drug storage portion 102, the drug supply portion 103, and the drug packaging portion 104) except for the drug inspection apparatus 10 is disclosed in the documents cited in the previously described prior art documents, and the like, and accordingly, the detailed description thereof will be omitted; but each configuration of the drug packaging apparatus 101 has the following functions.

The drug storage portion 102 stores a plurality of different drugs (drugs m), and when having received an output instruction of a drug to be dispensed according to a prescription instruction from a doctor, discharges the designated drug m by a designated amount and number of pieces. The drug supply portion 103 has a chute shape, collects a plurality of drugs m with the use of the falling gravity of the drugs m which have been discharged from the drug storage portion 102, and delivers the drugs m to the drug inspection apparatus 10 as a drug M. As shown in FIG. 1, the drug inspection apparatus 10 is arranged in the lower part of the chute of the drug supply portion 103, and when having received a plurality of drugs M, performs the inspection process of inspecting whether or not the designated amount of the above designated drug has been discharged. Then, the drug packaging portion 104 packages the drug M for which the inspection process in the drug inspection apparatus 10 has been finished, and discharges the drug M.

In the drug packaging apparatus 101, prescription data is input which indicates a content of the prescription of the drug. The prescription data designates, for example, the names and numbers of drugs to be taken respectively in the morning, in the daytime and in the evening, for one week. The drug packaging apparatus 101 discharges a designated number of drugs M to the drug supply portion 103, from the drug storage portion 102 in which the drugs are sorted according to the drug name which the prescription data indicates, and are stored. The number of drugs to be taken at one time is one type or one piece in some cases, but in many cases, is a plurality of types or a plurality of drugs. The drug packaging apparatus 101 continuously processes the above processing on the basis of the prescription data, thereby prepares, for example, packaged drugs of 21 pieces in total of the morning, daytime and evening of one week; and accordingly, the drugs M1, M2, M3 and so on (21 packaged drugs in total) are continuously charged into the drug inspection apparatus 10 as well. Accordingly, the drug inspection apparatus 10 performs the inspection process on the plurality of drugs M, while synchronizing the identification numbers that are assigned to the drugs M1, M2, M3 and so on, with the drug packaging apparatus 101. The inspection process by the drug inspection apparatus 10 is executed for all of the drugs M1, M2, M3 and so on, and as described above, an inspection processing result is obtained which is “normal” in which all of the drugs are normal, or “uncertain” in which at least a part of the drugs is uncertain. Then, the drug packaging apparatus 101 (for example, the drug inspection apparatus 10) acquires inspection processing result data based on the inspection processing result, displays the data on an unillustrated display means, and thereby can transmit the information to the pharmacist 108; and the pharmacist collates the packaged drug with the inspection processing result data, and confirms the result. Thereby, it becomes easy for the pharmacist to confirm the contents of the drug M.

For information, in FIG. 2, such an example is shown that the drug inspection apparatus 10 of the present invention is incorporated in the drug packaging apparatus 101, but the method of using the drug inspection apparatus 10 is not limited thereto. The drug inspection apparatus 10 can perform an individual inspection process of checking whether or not each drug m in a plurality of drugs M to be received matches the pre-registered drug information (drug master data or drug database) by the inspection control process. Accordingly, for example, regarding the drug M which has been already prescribed in one package, the drug inspection apparatus 10 can be used also as a means for knowing which drug of the registered drug information each drug m is.

Various configurations can be proposed, as the drug inspection apparatus 10 that realizes the objects as described above. Then, hereinafter, as a plurality of Examples of the drug inspection apparatus 10, the drug inspection apparatus 11 will be described in the Example 1, and the drug inspection apparatus 12 will be described in the Example 2.

### Example 1

FIG. 3 is a front view and a top view of the drug inspection apparatus 11 according to Example 1. When the drug inspection apparatus 11 shown in FIG. 3 is compared with the drug inspection 10 shown in FIG. 1, both apparatuses are largely apparatus different from each other in a point that in the drug inspection apparatus 10, the conveying means of the conveyance inspection processing portion 40 is a conveying belt, whereas in the drug inspection apparatus 11, the conveying means of the conveyance inspection processing portion 400 is a rotary disc 401, but have many common configurations.

Then, hereinafter, regarding each of components of the drug inspection apparatus 11, a component corresponding to the component of the drug inspection apparatus 10 will be described with the use of the same names. Specifically, for example, the conveyance inspection processing portion 400 included in the drug inspection apparatus 11 is a component corresponding to the conveyance inspection processing portion 40 included in the drug inspection apparatus 10. In addition, such unification of the names is also the same in a drug inspection apparatus 12 shown in Example 2.

The drug inspection apparatus 11 temporarily holds a plurality of received drugs m (drug M) in a pre-inspection storage portion 200. The drug M in the pre-inspection storage portion 200 is dropped to the transfer processing portion 300 which is arranged on the lower side, by a charge partition plate 202 in an opened state, and moves.

Then, in the transfer processing portion 300, a transfer push-out plate 302 pushes out the drug M and transfers the drug M to the rotary disc 401 constituting the conveyance inspection processing portion 400 in the subsequent stage.

The rotary disc 401 is a disc having a diameter of about 250 mm, and rotates at a constant rotation speed of 15 rpm. In the conveyance inspection processing portion 400, the drug M is placed in an elongated space having a width of about 20 mm, which is formed by the rotary disc 401 that continuously rotates in a horizontal direction and an inner circumferential guide 403 that is arranged on the inner circumferential surface of the rotary disc. When the drug M moves together with the rotary disc 401, the drug M is imaged from the upper surface and the lower surface, in an inspection imaging portion 500 which is arranged on the downstream side of the conveyance, and in which a camera 501 and an illumination lamp (reflection illumination) 502 are arranged in top and bottom. When the rotary disc 401 further rotates by about 180 degrees, the inner circumferential guide 403 on the rotary disc 401 moves in an outer circumferential direction, and thereby, the drug M is pushed out from the rotary disc 401 to the discharge processing portion 600; and furthermore, a discharge lever 602 of the discharge processing portion 600 operates in a direction of the rotary disc 401, and thereby, the drug M is moved to a post-inspection storage portion 700. Then, in the post-inspection storage portion 700, an unillustrated storage portion camera takes an image which indicates that the drug M is stored.

When the inspection process for the drug M is finished through the flow described above, the post-inspection storage portion 700 discharges the drug M by opening a discharge partition plate 702, and then closes the discharge partition plate 702; and after that, the storage portion camera takes an image of the post-inspection storage portion 700, and it is confirmed that the drug M does not remain.

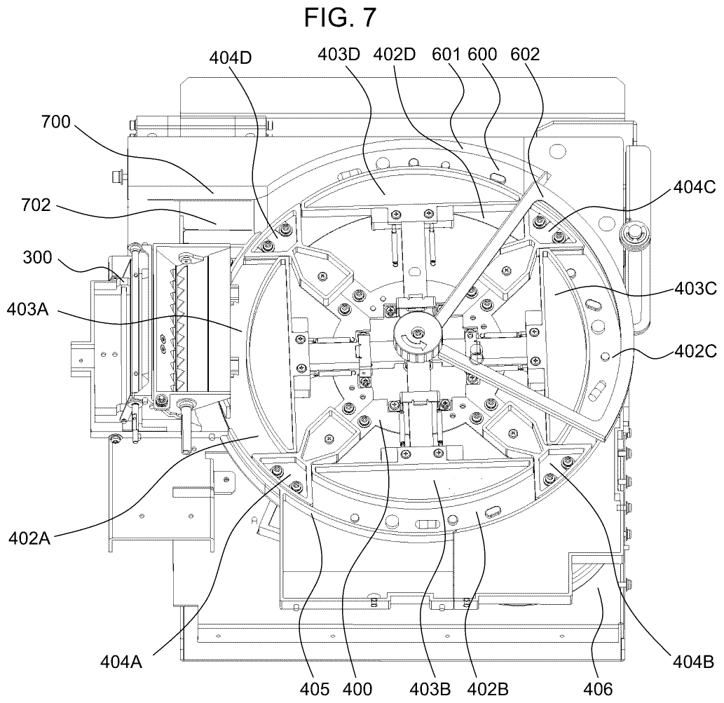

For information, in the rotary disc 401 which is used in the present Example, the outer circumferential portion of the rotary disc 401 is divided into four sections, and a circumference partition plate 404 for dividing the section is arranged at a boundary of each section (see FIG. 7). When a plurality of drugs M continue which the pre-inspection storage portion 200 receives (for example, when drugs M1, M2, M3 and M4 are continuously received), the above operation is repeatedly executed. However, the rotary disc 401 is divided into four sections, and accordingly, the drugs M1, M2, M3 and M4 are sequentially placed in the respective sections, and the imaging and the inspection process can be continuously performed.

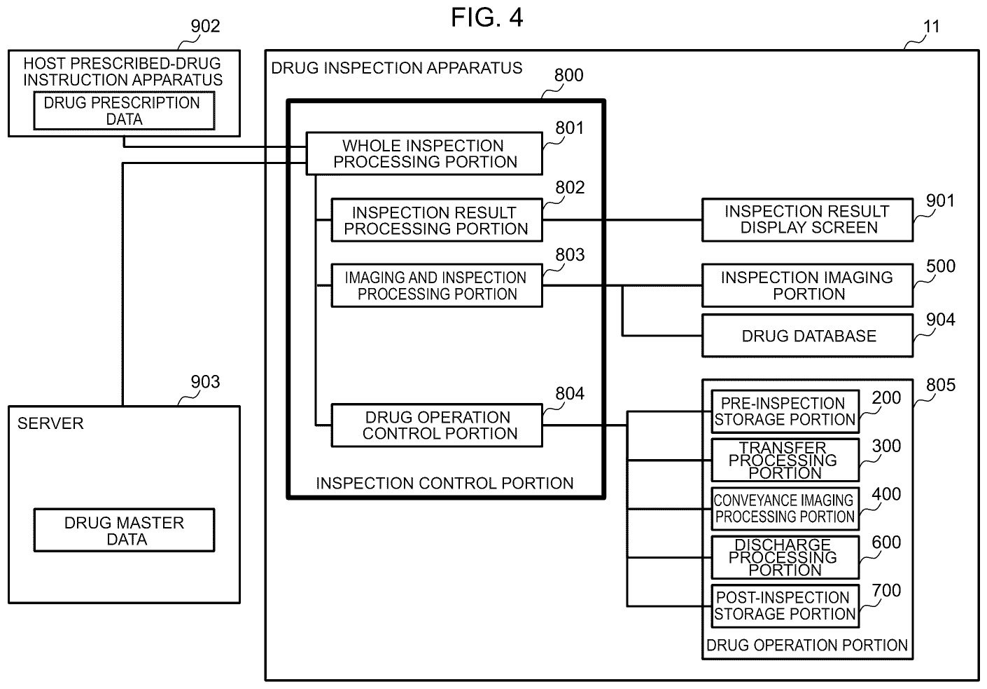

FIG. 4 is a block diagram showing an example of an internal configuration of the drug inspection apparatus 11, centering on an inspection control portion 800. The inspection control portion 800 has a configuration corresponding to the inspection control portion 80 of the drug inspection apparatus 10, and has a function of processing the conveyance, imaging and inspection of the drug M which has been received, in the drug inspection apparatus 11. As shown in FIG. 4, the inspection control portion 800 is configured to include an inspection result processing portion 802, an imaging and inspection processing portion 803, and a drug operation control portion 804 under a whole inspection processing portion 801 that performs an overall control process.

The whole inspection processing portion 801 is coupled to a host prescribed-drug instruction apparatus 902 which holds data (drug prescription data) of a drug to be prescribed; and acquires drug prescription data of the drug M to be received from the host prescribed-drug instruction apparatus 902, and outputs an inspection processing result thereto. The whole inspection processing portion 801 is coupled to a server 903 that holds basic data (drug master data) regarding various drugs, acquires master data of a drug to be prescribed from the server 903, and stores the master data in the drug database 904 of the imaging and inspection processing portion 803. In addition, the whole inspection processing portion 801 determines an operation method of the drug inspection apparatus 11, for example, on the basis of the drug prescription data which has been acquired from the host prescribed-drug instruction apparatus 902; instructs an operation process to an inspection result processing portion 802, the imaging and inspection processing portion 803, and the drug operation control portion 804; and in addition, outputs the inspection result of the drug M to an inspection result display screen 901 and the host prescribed-drug instruction apparatus 902. The inspection result display screen 901 is a screen for displaying the inspection result of the drugs in the drug inspection apparatus 10 for the pharmacist, and is realized by a display apparatus such as a display provided in (or coupled to) the drug inspection apparatus 10. More specifically, on the inspection result display screen 901, an initial screen of inspection selection, an inspection process screen, and an inspection correction screen are displayed, which will be described later.

The drug operation control portion 804 controls an operation of a drug operation portion 805 (specifically, the pre-inspection storage portion 200, the transfer processing portion 300, the conveyance inspection processing portion 400, the discharge processing portion 600, and the post-inspection storage portion 700) for the drug M which the drug inspection apparatus 11 receives, according to the operation method which the whole inspection processing portion 801 has determined.

The imaging and inspection processing portion 803 acquires an image of each drug m of the drug M which has been photographed by the inspection imaging portion 500 of the conveyance inspection processing portion 400; uses the image and the master data of each drug m contained in the drug prescription data which has been read from the drug database 904; compares and determines an outer size and color information of the drug m, and collates the images in the information of the engraved mark; thereby calculates the similarity between the photographed image and the master data; and determines the inspection result of each drug m on the basis of the calculated similarity, and outputs the inspection result. As the inspection result, for example, three types can be defined which are “normal”, “confirmation needed”, and “uncertain”. The inspection result of “normal” is determined when the similarity with one master data in the drug master data included in the drug prescription data has exceeded a predetermined threshold value. The inspection result of “confirmation needed” is determined when it has been determined that the similarity does not reach a threshold value but the data is similar to one master data of the drug master data contained in the drug prescription data. The inspection result of “uncertain” is determined when the similarity is low and the drug m is not similar to any master data of the drug contained in the drug prescription data, or when the drug m is similar to a plurality of drug master data. Then, the imaging and inspection processing portion 803 combines the inspection results of the individual drugs m and generates an inspection result of the drug M.

The inspection result processing portion 802 generates a screen for the pharmacist 108 to confirm from the result of the inspection which the imaging and inspection processing portion 803 has implemented for the drug M, and displays the screen on the inspection result display screen 901.

For information, when the drug inspection apparatus 11 of the present Example is used by being mounted in the inside of the drug packaging apparatus 101 as in the drug inspection apparatus 10 shown in FIG. 2, the host prescribed-drug instruction apparatus 902 is the same as the control portion of the drug packaging apparatus 101. In addition, the inspection control portion 800 is configured so that the inspection result processing portion 802, the imaging and inspection processing portion 803 and the drug operation control portion 804 in the inside can execute the process individually or in parallel under the control of the whole inspection processing portion 801, and thereby can realize a high-speed and high-precision inspection process, realize an inspection process which a pharmacist can easily use, and realize a process which is easily coupled to a host apparatus on software.

In the above, the configuration and functions of the drug inspection apparatus 11 according to Example 1 have been described with reference to FIG. 3 and FIG. 4. Hereinafter, the configurations of the pre-inspection storage portion 200, the transfer processing portion 300, the conveyance inspection processing portion 400, the inspection imaging portion 500, the discharge processing portion 600, and the post-inspection storage portion 700, the operations of the portions for the drug M and a method of controlling the drug operation portion 805 by the drug operation control portion 804 will be described in more detail with reference to the drawings.

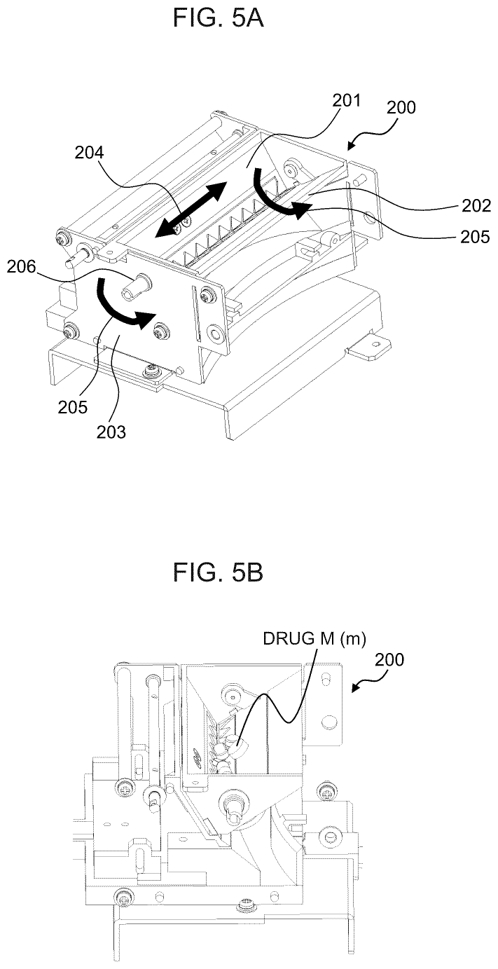

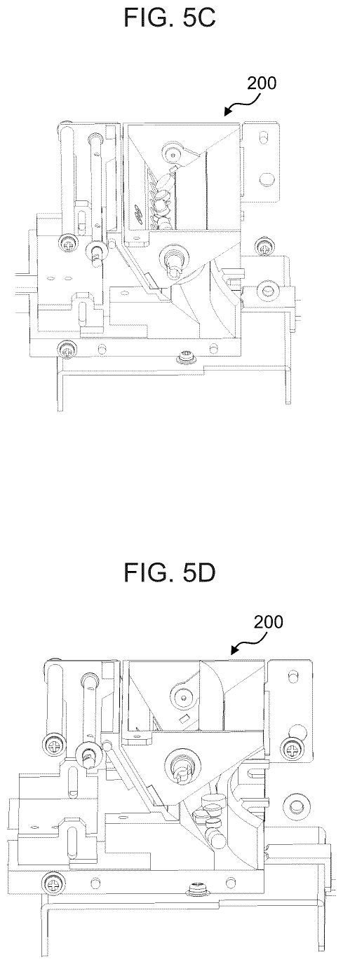

FIG. 5A to FIG. 5D are configuration diagrams (part 1 to part 4) of the pre-inspection storage portion 200. FIG. 5A is a perspective view of the pre-inspection storage portion 200, and FIG. 5B to FIG. 5D show the movement of the drug M in the pre-inspection storage portion 200, in time series.

As shown in FIG. 5A, the pre-inspection storage portion 200 includes a storage case 203, a charge vibration alignment portion 201 that receives the drug M to be charged, and a charge partition plate 202 that is rotatably supported by the charge vibration alignment portion 201, which are each attached to the inside of a storage case 203. The charge vibration alignment portion 201 is vibrated back and forth by an unillustrated driving source in a direction of an arrow 204 by about 5 mm, and thereby spreads the accumulated drugs M. The charge partition plate 202 is a door installed between the charge vibration alignment portion 201 and the transfer processing portion 300; and the charge partition plate 202 is opened by being rotated in a direction of an arrow 205 around a rotary shaft 206 by an unillustrated driving source, and thereby, the drug falls from the charge vibration alignment portion 201.

FIG. 5B shows a state in which a plurality of drugs overlap each other in a state in which the drug M (the plurality of drugs m) has fallen from the charge vibration alignment portion 201. The charge vibration alignment portion 201 and the charge partition plate 202 form a V-shaped valley shape. In the V-shaped valley shape, inclined surfaces forming the V-shaped valley shape are set to be steep inclined surfaces of about 45 degrees so that the individual drugs m falling by the influence of gravity easily spread along the elongated V-shaped valley, and the inclined surfaces are set to be about 100 mm in the longitudinal direction in consideration of the size and the number of the drugs m.

FIG. 5C shows a state in which the plurality of drugs m shown in FIG. 5B are spread by a vibration operation in the direction of the arrow 204. In order to spread the stacked drugs m by the horizontal vibration operation, it is effective to apply different acceleration to each drug. Because of this, a portion of the V-shaped valley surface of the charge vibration alignment portion 201 and the charge partition plate 202 which comes into contact with the drug is formed to be a groove shape, and thereby, it becomes possible to apply a larger acceleration to the drug which has come into contact with the V-shaped groove than the stacked drugs, by the vibration operation in the horizontal direction (in the direction of the arrow 204) by the driving source, and to spread the stacked drugs m at a high speed.

FIG. 5D shows a state in which the drug M has fallen downward by the charge partition plate 202 which is rotated in the direction of the arrow 205 around the rotary shaft 206. In the pre-inspection storage portion 200, the rotary shaft 206 connected to the charge partition plate 202 is arranged above the V-shaped groove, and thereby, when the rotary shaft 206 has been rotated in the direction of the arrow 205, the charge partition plate 202 can be shifted to an opened state at a high speed, from a state of having formed the V-shaped groove with a inclined surface of about 45 degrees by substantially contacting the charge vibration alignment portion 201, in FIG. 5C. As a result, the drugs M held in the spread state on the charge partition plate 202 in FIG. 5C can be reliably dropped at a high operation speed while the spread state is held, as shown in FIG. 5D.

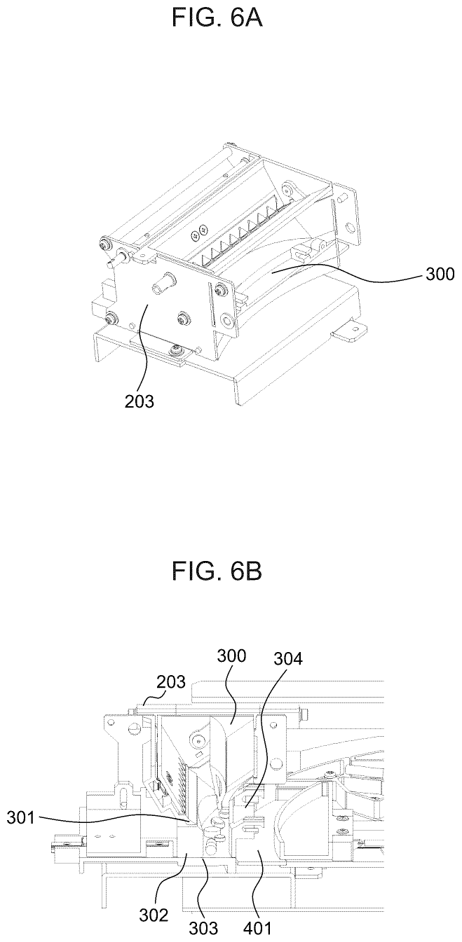

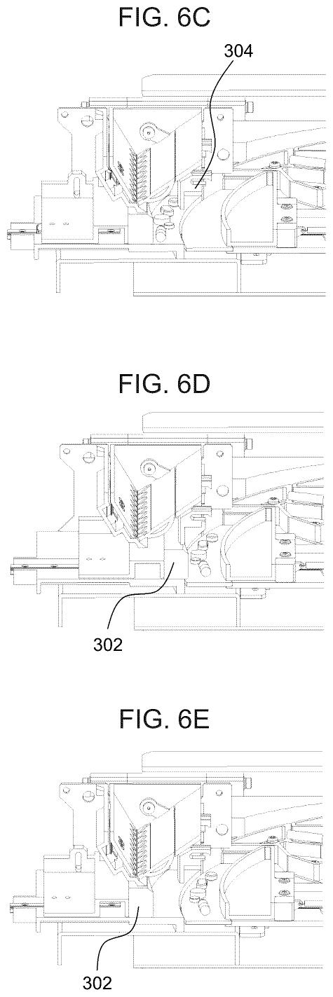

FIG. 6A to FIG. 6E are configuration diagrams (part 1 to part 5) of the transfer processing portion 300. FIG. 6A is a perspective view of the transfer processing portion 300, and FIG. 6B is a cross-sectional view of the transfer processing portion 300. In addition, FIG. 6C to FIG. 6E show the movement of the drug M in the transfer processing portion 300, in time series.

The transfer processing portion 300 is arranged in the inside of the storage case 203 which constitutes the pre-inspection storage portion 200. To be more specific, as shown in FIG. 6A and FIG. 6B, the transfer processing portion 300 is configured to include: a transfer guide 301 for guiding the falling drug M, a transfer push-out alignment portion 303 for holding the drug M having fallen in the spread state; a transfer push-out plate 302 for pushing out the drug M on the transfer push-out alignment portion 303 toward the rotary disc 401 of the next stage; and a transfer portion shutter 304 which is arranged between the transfer push-out plate 302 and the rotary disc 401 and opens and closes by an vertical operation, each in the inside of the storage case 203.

As shown in FIG. 5C to FIG. 5D, when the drugs M fall from the pre-inspection storage portion 200 in the spread state, the drugs M are guided by the transfer guide 301 and the inclined surface of the transfer push-out plate 302, and a plurality of drugs m are held in the spread state without overlapping in an elongated shape, while the drugs M maintain the spread state on a flat surface partitioned by the transfer portion shutter 304 on an upper surface of the transfer push-out alignment portion 303.

After that, as shown in FIG. 6C, the transfer portion shutter 304 is moved upward to become an opened state, and further, as shown in FIG. 6D, the transfer push-out plate 302 is moved on the transfer push-out alignment portion 303 toward a direction of the transfer portion shutter 304. As a result, the drugs M are pushed out and moved onto the rotary disc 401 while maintaining the spread state. Then, after the drugs M have been pushed out onto the rotary disc 401, the transfer push-out plate 302 is returned to the original position, as shown in FIG. 6E.

Here, the transfer portion shutter 304 is formed into an arc shape so as to be in contact with the circumference of the rotary disc 401, and the tip of the transfer push-out plate 302 is also similarly formed into an arc shape; and thereby, the plurality of drugs m can be pushed out to the rotary disc 401 simultaneously in a state in which the spread state is maintained. In addition, when the drug M is transferred from the transfer guide 301 to the rotary disc 401, if the gap is large or the step is large, the spread state of the drugs is adversely affected, and accordingly, it is preferable to configure the gap in the horizontal direction and the step in a falling direction so as to become minimum within a possible range.

FIG. 7 is a configuration diagram of the conveyance inspection processing portion 400, the discharge processing portion 600 and the post-inspection storage portion 700.

The conveyance inspection processing portion 400 shown in FIG. 7 has the rotary disc 401 having a diameter of about 250 mm, which is continuously rotated horizontally at a constant rotation speed of 15 rpm by an unillustrated drive motor. In the rotary disc 401, the outer circumferential portion of the rotary disc 401 is divided into four sections, and four circumference partition plates 404 (individually, circumference partition plates 404A to 404D) are arranged so as to form the four divided sections; and four inner circumferential guides 403 (individually, inner circumferential guides 403A to 403D) are arranged on the inner circumferential surface of the rotary disc 401, and thereby, a circumference mounting plate 402 (for individual sections, circumference mounting plates 402A to 402D) formed as an elongated surface having a width of about 20 mm, on which each drug m of the drug M is placed. Thus, the rotary disc 401 rotates on a support frame 406.

The circumference mounting plate 402 uses a material having transparency (transparent body) such as an acrylic plate or a glass plate, and thereby, the drugs m which have been placed on the circumference mounting plate 402 can be imaged from both the upper surface and the lower surface, as will be described later. In addition, the transfer processing portion 300 is arranged above the support frame 406 at a position in contact with the rotary disc 401.

Hereinafter, the conveyance of the drug will be described, which corresponds to the rotation of the rotary disc 401. In order to make this description easier to understand, among the four sections divided on the rotary disc 401, the quadrant including the arranged position of the transfer processing portion 300 shall be referred to as “quadrant 1”, and remaining quadrants shall be referred to as “quadrant 2”, “quadrant 3” and “quadrant 4” at intervals of 90 degrees, along the downstream side in the rotation direction from the quadrant 1. In addition, in the drawings, the respective members on the previously described rotary disc 401 can be referred to in such forms that reference numerals A to D are attached so as to correspond with the quadrants 1 to 4. For example, a circumference mounting plate 402A corresponds to the circumference mounting plate 402 of the quadrant 1, a circumference mounting plate 402B corresponds to the circumference mounting plate 402 of the quadrant 2, a circumference mounting plate 402C corresponds to the circumference mounting plate 402 of the quadrant 3, and a circumference mounting plate 402D corresponds to the circumference mounting plate 402 of the quadrant 4.

When the four sections divided on the rotary disc 401 are in a state shown in FIG. 7, in the quadrant 1, the transfer portion shutter 304 is opened at the timing when the circumference mounting plate 402A passes through the position facing the transfer portion shutter 304 by the rotation of the rotary disc 401, and the transfer push-out plate 302 is pushed out; and thereby, the drug M is moved onto the circumference mounting plate 402A. In addition, the drug M moved onto the circumference mounting plate 402A is rotated together with the inner circumferential guide 403A and the circumference partition plates 404A and 404D.

For information, in the present description, it is assumed that when the drug M is transferred onto the circumference mounting plate 402A of the quadrant 1, the drugs M have been already placed on the respective circumference mounting plates 402B, 402C and 402D of the other respective quadrants 2, 3 and 4.

At this time, in the quadrant 2, the drug M placed on the transparent circumference mounting plate 402B is conveyed between a rotating inner circumferential guide 403B and a fixed outer circumferential guide 405, and at this time, the inspection imaging portion 500 performs an imaging process which will be described later. Though details will be described later, the inspection imaging portion 500 has a camera 501A and a reflection illumination 502A for taking a picture from above the circumference mounting plate 402 and a camera 501B and a reflection illumination 502B for taking a picture from below the circumference mounting plate 402, which are arranged in the quadrant 2.

On the other hand, in the quadrant 3, the drug M is conveyed in a state of being placed on a circumference mounting plate 402C.

On the other hand, in the quadrant 4, an inner circumferential guide 403D is pushed out toward the outer circumferential direction by an unillustrated movable mechanism which uses a rotary cam mechanism, and thereby, the drug M on a circumference mounting plate 402D is discharged from the rotary disc 401.

As described above, the conveyance inspection processing portion 400 of FIG. 7 executes a series of operations from the transfer to the discharge through the conveyance in parallel at different timings for each quadrant in accordance with the rotation of the rotary disc 401, and thereby, can continuously convey drugs of four drugs M at the maximum at the same time.

An operation after the drug M has been discharged from the conveyance inspection processing portion 400 will be also described while referring to FIG. 7.

As shown in FIG. 7, in the quadrant 4, the discharge processing portion 600 is arranged that receives the drug M which has been discharged from the rotary disc 401. The discharge processing portion 600 is configured to include: a discharge guide 601 that holds the drug M pushed out from the rotary disc 401; and a discharge lever 602 that is operated on the discharge guide 601 in a rotation direction of the rotary disc 401, by an unillustrated driving source. The drug M that has been pushed out from the rotary disc 401 in the quadrant 4 is held by the discharge guide 601 of the discharge processing portion 600, then is pushed out by an operation of the discharge lever 602, and moves to the post-inspection storage portion 700.

The post-inspection storage portion 700 is configured to include: a discharge partition plate 702 that is a plate which holds the drug M pushed out by the discharge lever 602 and moves while being opened and closed in the horizontal direction by an unillustrated driving source; and a storage portion camera that takes an image of the drug M on the discharge partition plate 702.

The storage portion camera takes an image indicating that the drug M is stored in the discharge partition plate 702. Then, when the inspection processing of the drug M has been finished, the discharge partition plate 702 of the post-inspection storage portion 700 moves to the opened state, and thereby, the drug M is discharged from the drug inspection apparatus 11; after that, the discharge partition plate 702 is switched to a closed state; and the storage portion camera takes an image of the discharge partition plate 702, and thereby, it is confirmed that the drugs do not remain.

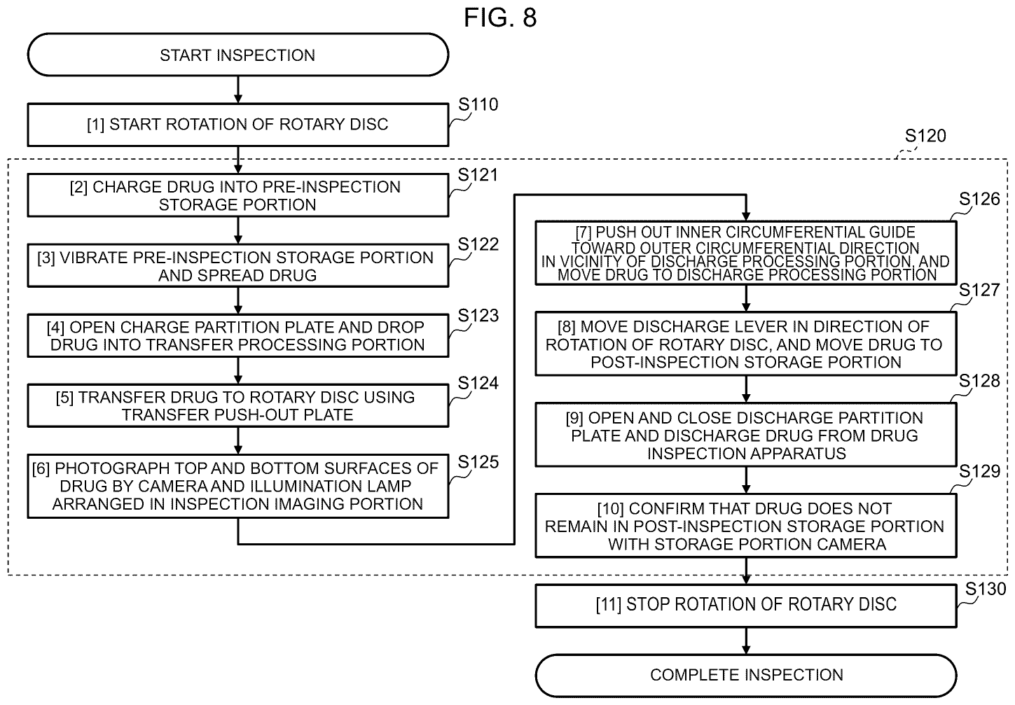

FIG. 8 is a flowchart showing an example of a processing procedure of a control process by the drug operation control portion 804. FIG. 8 shows an operation flow from the time when the drug is charged into the drug inspection apparatus 11 to the time when the drug is aligned, an inspection image of the drug is taken, the drug is inspected, and the drug is discharged. As described previously, the drug operation control portion 804 controls operations of the pre-inspection storage portion 200, the transfer processing portion 300, the conveyance inspection processing portion 400 (including the inspection imaging portion 500), the discharge processing portion 600, and the post-inspection storage portion 700, for the drug M which the drug inspection apparatus 11 has received, according to an operation method which the whole inspection processing portion 801 has determined. Hereinafter, each process shown in the process flow of FIG. 8 will be described, but for the sake of simplicity, the description will be omitted which indicates that a main body of control for each process is the drug operation control portion 804.

According to FIG. 8, firstly, when the inspection of the drug M is started which the drug inspection apparatus 11 has received, the rotation of the rotary disc 401 of the conveyance inspection processing portion 400 starts (step S110).

Then, in a period until the rotation of the rotary disc 401 is stopped in step S130 which will be described later, the drug inspection apparatus 11 (the drug operation control portion 804) performs the alignment, photographing, inspection of the drugs and the like, while conveying the drug M to a predetermined flow path which sequentially passes through the pre-inspection storage portion 200, the transfer processing portion 300, the conveyance inspection processing portion 400, the discharge processing portion 600, and the post-inspection storage portion 700 (step S120). For information, in the step S120, the processes of steps S121 to S129 are executed as will be described below in detail.

Firstly, as having been described in detail with reference to FIG. 5A to FIG. 5D, the drug M is charged into the pre-inspection storage portion 200 (step S121); and the charge vibration alignment portion 201 is vibrated in the pre-inspection storage portion 200, and thereby spreads the drug M (the plurality of drugs m) (step S122).

Furthermore, in the pre-inspection storage portion 200, the drug inspection apparatus 11 opens the charge partition plate 202, and drops the drug M to the transfer processing portion 300 in a state in which drugs are spread (step S123).

Next, as having been described in detail with reference to FIG. 6A to FIG. 6E, the drug inspection apparatus 11 operates the transfer push-out plate 302 of the transfer processing portion 300, and thereby transfers the drug M onto the rotary disc 401 of the conveyance inspection processing portion 400 (step S124).

As described in detail with reference to FIG. 7, the drug M which has been transferred onto the rotary disc 401 (for example, quadrant 1) in step S124 moves as the rotary disc 401 rotates. Then, in the middle of the movement (for example, quadrant 2), the upper and lower surfaces of the drug M are photographed by the camera 501 and the illumination lamp 502 which are arranged in the inspection imaging portion 500 (step S125). After that, when the drug M is moved to the vicinity of the discharge processing portion 600 (for example, quadrant 4) by the rotation of the rotary disc 401, the inner circumferential guide 403 is pushed out toward the outer circumferential direction, and thereby moves the drug M to the discharge processing portion 600 (step S126).

Next, in the discharge processing portion 600, the discharge lever 602 is operated toward the rotation direction of the rotary disc 401, and thereby the drug M is moved to the post-inspection storage portion 700 (step S127). Next, in the post-inspection storage portion 700, the drug M is discharged from the drug inspection apparatus 11 by an opening operation of the discharge partition plate 702 (step S128). Then, after the discharge partition plate 702 has performed the closing operation, it is confirmed that the drug M does not remain in the post-inspection storage portion 700 due to photographing by the storage portion camera (step S129).

The above processes are the detailed processes of step S120. Then, when the processes of steps S121 to S129 are finished and it is confirmed that all the drugs M of the inspection target are discharged from the drug inspection apparatus 11, the drug operation control portion 804 stops the rotation of the rotary disc 401 (step S130), and the inspection of the drugs M is finished.

For information, the above process in step S120 is a process for one time charging of the drug M to the drug inspection apparatus 11. The drug inspection apparatus 11 is configured so as to be also capable of coping with continuous charge of a plurality of drugs M; and when the drugs M are continuously charged, as having been described with the use of the quadrants 1 to 4 in the description of FIG. 7, the process of step S120 corresponding to each charge needs to be executed in parallel.

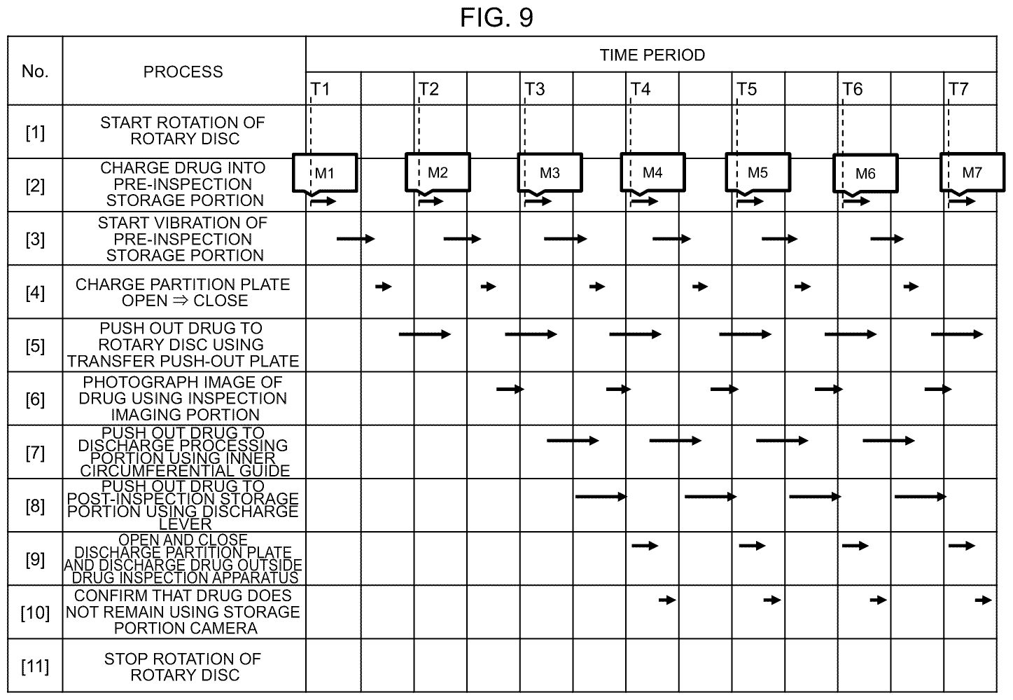

FIG. 9 is a diagram showing an example of a process transition of the inspection process at the time when a plurality of drugs are continuously charged. In FIG. 9, a plurality of drugs M which are continuously charged are represented as drugs M1 to M7 in an order of being charged, and a process transition of the inspection process for each drug M is shown. For information, the numbers (No.) of [1] to shown in FIG. 9 correspond to the numbers assigned to the respective processes of the inspection process shown in FIG. 8, and in the description of FIG. 9, the respective processes are expressed with the use of the numbers of the above [1] to [11]. In other words, in FIG. 9, the process of step S110 in FIG. 8 is referred to as “process 1”, the process of step S121 is referred to as “process 2”, and so on; and thus, the process of step S130 is referred to as “process 11”. In addition, in FIG. 9, the timing at which the process 2 is started for a drug Mn which is charged as a n-th charge is represented by “time Tn”.

According to FIG. 9, for the first drug M1, the process 2 starts at the time T1, and a process 10 ends in the middle between the time T4 and the time T5. In the middle of this operation, an operation of transferring the drug M1 to the rotary disc 401 by the transfer push-out plate 302 in the process 5 is executed in synchronization with the rotational position of the rotary disc 401. Then, at the timing in conjunction with the operation of the process 5, an operation of the process 2 for the next drug M2 is started. Such cooperation of the starts of the operation is the same in a subsequent drug M3 and thereafter.

Here, a difference between the time T2 at which the process 2 for the drug M2 is started and the time T1 is a processing cycle length Ts. The rotary disc 401 is divided into four, and accordingly it is recommended to set a rotation cycle length of the rotary disc 401 to be four times as long as Ts. For a consecutive process of the drug M, for example, at the time T4, the drug inspection apparatus 11 (the drug operation control portion 804) executes the process 6 for the drug M2 while executing the process 9 for the drug M1, executes the process 5 for the drug M3, and executes the process 2 for the drug M4, in parallel. Due to such execution, the drug inspection apparatus 11 can periodically execute the inspection process with respect to the drugs M which are continuously charged, by a concurrent processing control.

Furthermore, in FIG. 9, the drugs M1 to M7 are charged at periodically synchronized timings, but when the timing of charging the drug M is delayed for some reason, for example, when the drug M4 is not charged at the timing of the time T4, the drug inspection apparatus delays the series of inspection processes for the drug M4 by processing cycle length Ts for one charge, and starts the inspection processes at the time T5; and then, can execute the execution of the process 2 to process 10 in synchronization with the processes for other drugs M.

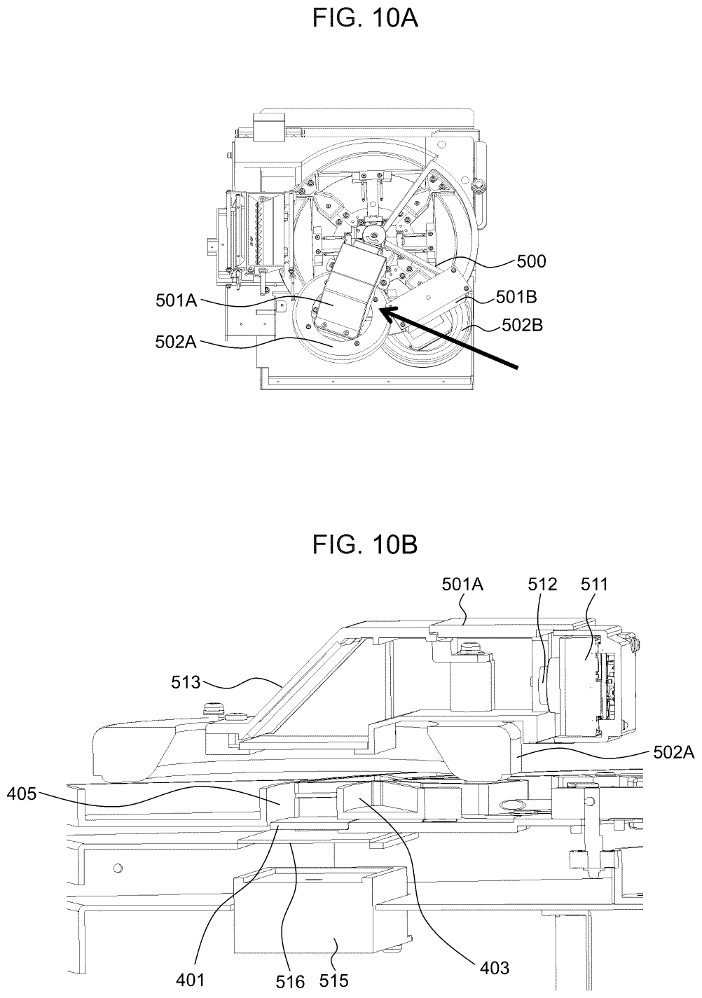

FIG. 10A and FIG. 10B are configuration diagrams (part 1 and part 2) of the inspection imaging portion 500. FIG. 10A is a top view of the inspection imaging portion 500, and FIG. 10B is a cross-sectional view of the inspection imaging portion 500, which is viewed from the direction of the arrow in FIG. 10A.

The inspection imaging portion 500 arranges the cameras 501 and the illumination lamps 502 on the upper side and the lower side of the circumference mounting plate 402 in the quadrant 2, respectively; and when the conveyance inspection processing portion 400 conveys the drugs M held in the spread state on the circumference mounting plate 402 in a counterclockwise direction at a constant speed, continuously takes a picture of the drug M at a constant interval in the order of the camera 501 in the upper side (upper camera 501A) and the camera 501 in the lower side (lower camera 501B). When the drugs M1, M2, M3 and M4 are continuously charged, the inspection imaging portion 500 performs an imaging process for the drugs M1, M2, M3 and M4 which are held on the circumference mounting plates 402A, 402B, 402C and 402D shown in FIG. 7, when the respective drugs are conveyed in the quadrant 2.

As shown in FIG. 10A, the upper camera 501A is arranged on the upper side of the circumference mounting plate 402, whereas the lower camera 501B is arranged on the lower side of the circumference mounting plate 402, and takes an image of the drug M through the circumference mounting plate 402 made of a transparent material. The upper camera 501A and the lower camera 501B are arranged to be optically vertically symmetrical by being shifted by a predetermined amount in the rotation direction of the rotary disc 401, and thus it is possible to achieve commonality of the imaging process in the inspection process.

Both the upper camera 501A and the lower camera 501B have the camera elements 511 and the lenses 512 arranged so as to be capable of taking a picture without causing distortion in four directions in the imaging area of 25 to 30 mm, in consideration of a widthwise size (about 20 mm) of the elongated circumference mounting plate 402 and the size of the drug M; and in order to minimize the mounting size, have such a structure of an L-shaped optical path as to take the image of the drug M, which has been reflected by a mirror 513.

Both the reflection illumination 502A which is arranged for photographing by the upper camera 501A and the reflection illumination 502B which is arranged for photographing by the lower camera 501B employ such an annular illumination lamp as to be capable of illuminating the individual drugs m from an oblique side, in order to take a clear picture of the images (particularly, marks or engraved marks on the surfaces) of the drugs. In addition, in order to reduce unevenness in the directionality of illumination lamp, it is desirable not only to make the circumference mounting plate 402 transparent, but also to use a transparent material for the inner circumferential surfaces of the inner circumferential guide 403 and the outer circumferential guide 405.

In addition, in the present Example, the inspection imaging portion 500 contains imaging for an outer shape by transmission illumination, so as to enable imaging for a special drug such as a transparent tablet. To be specific, the inspection imaging portion 500 arranges a transmission illumination 515 and a semi-transmission sheet 516 on the opposite side of the upper camera 501A of the circumference mounting plate 402, in other words, on the back surface side of the drug m, in a form of being combined with the upper camera 501A. In addition, similarly, the transmission illumination 515 and the semi-transmission sheet 516 are arranged in a form of being combined with the lower camera 501B.

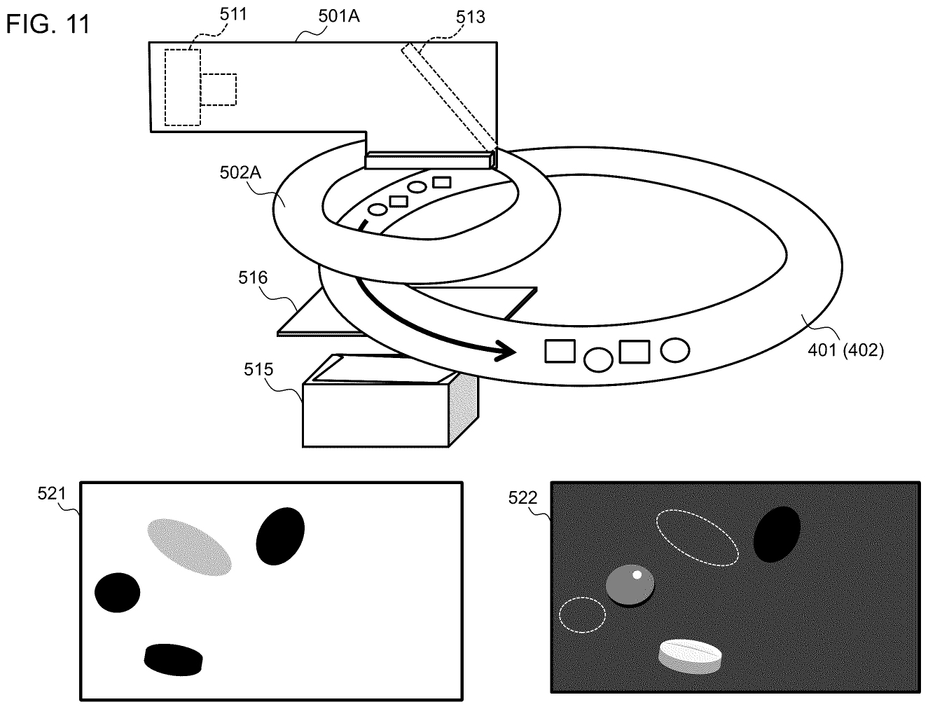

FIG. 11 is a schematic diagram for describing an imaging operation by the inspection imaging portion 500. For information, FIG. 11 shows the arrangement relationship of the optical system configuration such as the camera and the illumination lamp, in the case of the upper camera 501A which is an example, but the case of the lower camera 501B may also be considered in the same way. In the inspection imaging portion 500, an operation of taking a picture of the drug by the camera 501 while alternately switching the transmission illumination 515 and the reflection illumination 502 will be described below with reference to FIG. 11.

Firstly, at the time of taking a picture of the upper side, the upper camera 501A turns on the reflection illumination 502A which is arranged around the periphery, and takes a picture of the drug on the rotary disc 401 (the circumference mounting plate 402) from the top face; and thereby acquires the forward light image 522 in which a surface of the drug is imaged. At this time, the transmission illumination 515 is turned off.

Next, at the time of taking a picture of the lower side, the transmission illumination 515 below the semi-transmission sheet 516 is turned on, and the upper camera 501A takes a picture of the drug M from the top face in such a state that the drug on the rotary disc 401 (the circumference mounting plate 402) is illuminated from the lower side through the semi-transmission sheet 516 and the rotary disc 401; and thereby acquires a backlight image 521 in which an outer shape (shadow picture) of the drug is imaged. At this time, the reflection illumination 502A is turned off. The semi-transmission sheet 516 is a sheet member that does not reflect the illumination light emitted from the reflection illumination 502A, and transmits the illumination light emitted from the transmission illumination 515; and may be, for example, a black attenuation filter. In addition, as will be described later, it is preferable that a surface of the semi-transmission sheet 516 on the side of the circumference mounting plate 402 is black or a color similar to black.

As described above, the upper camera 501A alternately repeats the upper side imaging by the transmission light and the lower side imaging by the reflection light, and acquires the forward light image 522 and the backlight image 521. As a result, images can be acquired which are color images (forward light images 522) and outer shape images (backlight imaged 521) of the shadow pictures of both surfaces of the upper side and lower side of the drug. For information, the lower camera 501B also takes pictures of the upper side and the lower side, in the same procedure as the upper camera 501A (however, the upper and lower sides are reversed).

For information, when the upper side imaging and the lower side imaging are repeated, it is possible to acquire the backlight image 521 and the forward light image 522 that have been obtained by continuous imaging of the drug M which revolves and moves, by continuously imaging camera images in synchronization with the switching, while periodically switching the light for illuminating the drug between the reflection light and the transmission light, by periodically switching the illumination lamp to be turned on (the reflection illumination 502 and the transmission illumination 515) in several 10 ms cycles. In addition, as having been previously described, the upper camera 501A and the lower camera 501B are arranged so as to deviate in the rotation direction of the rotary disc 401 by a predetermined amount, and accordingly a difference in time periods occurs between the photographed images of the drug M, which have been photographed by both cameras.

Accordingly, when the upper side imaging and the lower side imaging are performed by the upper camera 501A and the lower camera 501B, respectively, the photographed images at different time periods can be acquired in the forward light image 522 and the backlight image 521, respectively, and an effect of improving the identification accuracy of the drug can be expected.

Then, the imaging and inspection processing portion 803 compares the image which has been cut out for each drug m, from the images of the drug M captured by the upper camera 501A and the lower camera 501B, with information such as a color, an outer shape and an engraved mark of master data for each drug m, which have been registered in advance; and determines the drug M as “normal”, if the matching rate is a certain level or more. If the result is not normal, it is determined as “confirmation needed” or “uncertain” according to the matching rate.

In the inspection imaging portion 500 described above, the transmission illumination 515 and the black semi-transmission sheet 516 are arranged close to each other, and thereby, when the drug is photographed by the transmission light (for example, lower side photographing by the upper camera 501A), a white color which is a color of the illumination light of the transmission illumination 515 transmits through the semi-transmission sheet 516 and the rotary disc 401 (the circumference mounting plate 402) to become a background color of the drug m, and the drug m itself is photographed in a state of a shadow picture of black or gray. In the backlight image 521 photographed in this way, as shown in FIG. 11, the outline of the transparent body or the dark drug is easily seen.

On the other hand, in the photographing by the reflection light (for example, the upper side photographing by the upper camera 501A), the light by the reflection illumination 502 does not transmit through the semi-transmission sheet 516, because the reflection illumination 502 and the semi-transmission sheet 516 are separated from each other, and the black color of the surface of the semi-transmission sheet 516 becomes a background color of the drug m. When the background color of the forward light image 522 is black in this way, the photographed drugs m are easily identified, because many of the drugs m are whitish. In addition, as having been previously described, in order to take a clear picture of the shadow of the mark or engraved mark on the surface of the drug m, the reflection illumination 502 illuminates the drug m from an oblique side surface.

In this way, the inspection imaging portion 500 acquires the inspection image by switching the illumination lamp, and thereby, the imaging and inspection processing portion 803 can be used for the purpose of inspecting the drug m with the use of an easy-to-see image, or tracking the movement of each of the drugs m and cutting out the image individually. A black attenuation filter may be used as the semi-transmission sheet 516.

As having been described above, the drug inspection apparatus 11 according to the present Example takes an inspection image on the way of aligning and conveying the received drug M (a plurality of drugs m), analyzes the image, thereby performs an inspection on each drug m included in the drug M, and can obtain an inspection result for the drug M by combining inspection results for the individual drugs m. The inspection result obtained in this way is displayed on an inspection result display screen 901 by the inspection result processing portion 802, and is presented to the pharmacist 108.

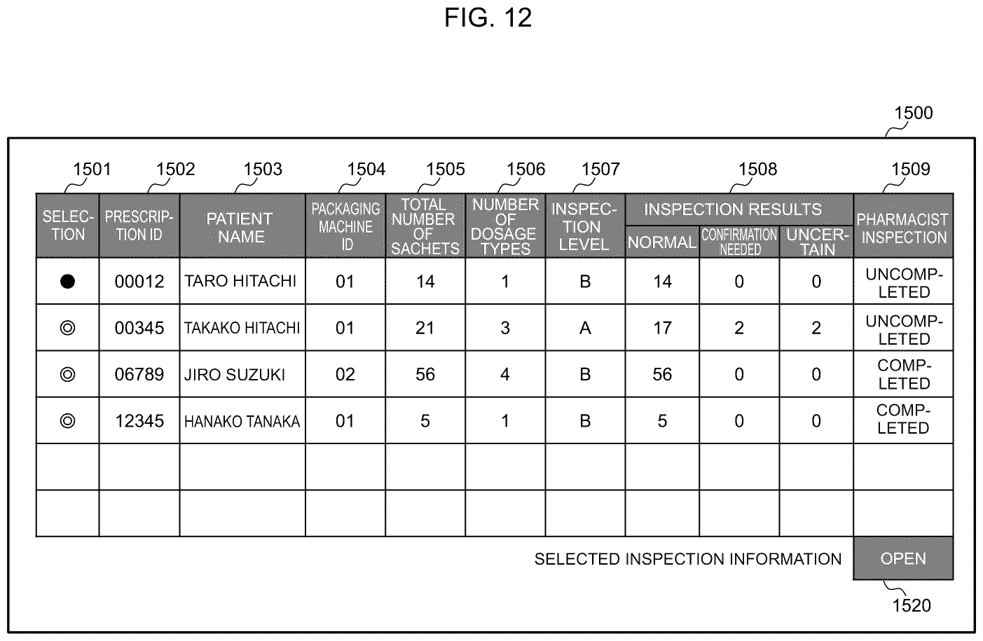

Then, the pharmacist 108 operates the inspection result display screen 901 which displays the inspection results, checks whether the packaged drugs M1, M2 and so on match the prescription information (drug prescription data), corrects the inspection result if the inspection result is uncertain or is different from the prescription information, and completes the drug inspection. Hereinafter, the output of screen which is displayed on the inspection result display screen and an operation by the pharmacist will be described with reference to FIG. 12 to FIG. 15.

FIG. 12 is a diagram showing an example of the initial screen of the inspection selection. The initial screen of the inspection selection is a screen which is operated when the pharmacist selects the drug M to be inspected, and a specific example thereof is shown in FIG. 12.

The initial screen of the inspection selection 1500 shown in FIG. 12 displays: a button 1501 for selecting the drug M; a prescription ID 1502 which becomes key information for selection; a patient name 1503; a packaging machine ID 1504; a total number of sachets 1505 which are included in the prescription information of each drug M; the number of dosage types 1506, which indicates the number of types of time point dosage of medication such as “after breakfast” and “before going to bed”; an inspection level 1507; an inspection result 1508; and a pharmacist inspection 1509.

The inspection level 1507 is information for distinguishing between a case where the drug m which is an individual tablet included in the drug M is a drug which needs strict inspection such as a high-risk drug, and a case where the drug m is a normal drug, and it is also considered that strict drug inspection is operated by limiting a person who should inspect (in such a way that a pharmacist needs inspection, a plurality of pharmacists needs inspection and even a clerk can inspect) according to the level.

In the inspection result 1508, three types of “normal”, “confirmation needed”, and “uncertain” are defined, as the inspection result for the individual drug m by the drug inspection apparatus 11, and the breakdown numbers in the total number of sachets are displayed for each of prescription IDs 1502. Here, “normal” means a case in which the tablet can be identified and inspected to follow the content designated in the prescription information (drug prescription data); “confirmation needed” means a case in which the tablet can be sorted according to the content designated in the prescription information but the similarity by comparison and identification with the tablet master data is low, and confirmation by the pharmacist is desirable; and “uncertain” means a case in which the tablet cannot be even sorted according to the content designated in the prescription information.

In the pharmacist inspection 1509, information such as “completed” or “uncompleted” is displayed as a status indicating whether or not the inspection by the pharmacist has been completed for each drug M.

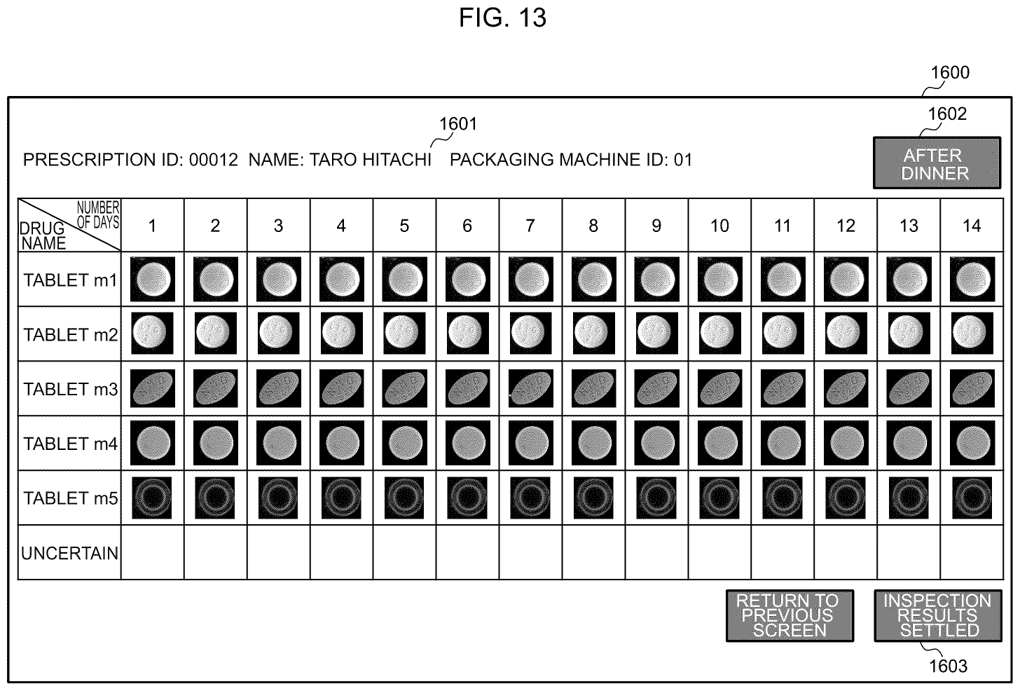

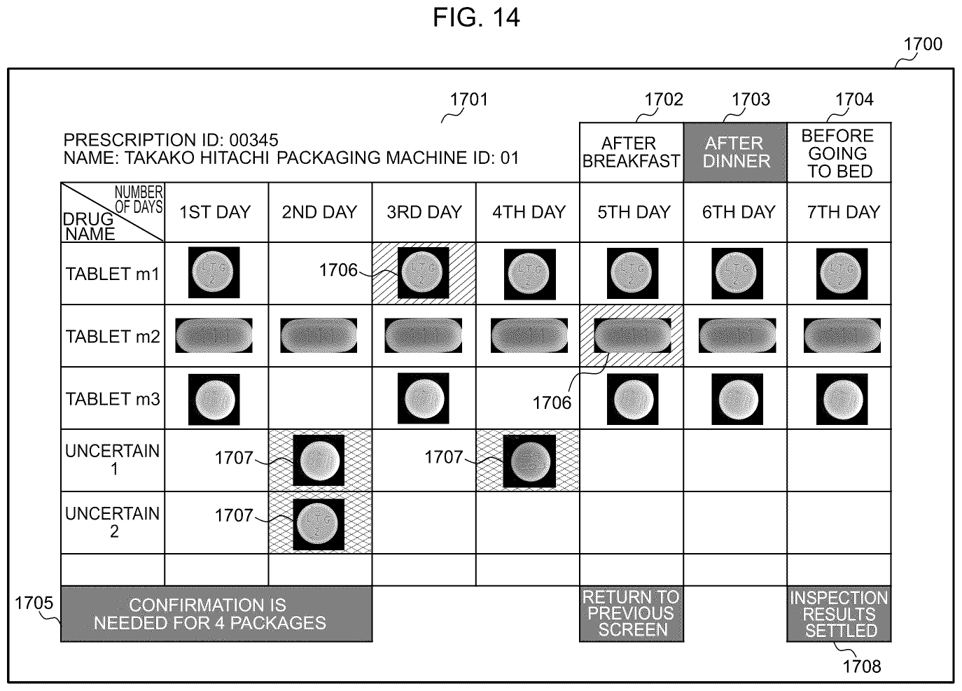

The pharmacist views the initial screen of the inspection selection 1500, selects a prescription ID (the drug M to be inspected) to be handled (for example, selects the first record 1510), presses the button 1520, and thereby displays an inspection process screen for the selected prescription ID (the drug M to be inspected). Specific examples of the inspection process screen are illustrated in FIG. 13 and FIG. 14.

FIG. 13 is a diagram showing one example of the inspection process screen. The inspection process screen 1600 shown in FIG. 13 is a specific example of the inspection process screen in the case where all the inspection results by the drug inspection apparatus 11 for the drug M1 are “normal” and there is no drug (tablet) m of “confirmation needed” or “uncertain”.

The inspection process screen 1600 displays information 1601 such as a prescription ID of the drug M1, a patient name and an inspected packaging machine ID, and then, displays a list of photographed images of individual drugs (tablets) m contained in the drug M1. This list display is in a table format which shows the drug names of the tablets m1 to m5 in each row and the number of prescription days which have been prescribed in each column, and displays the time point dosage in a tab 1602.

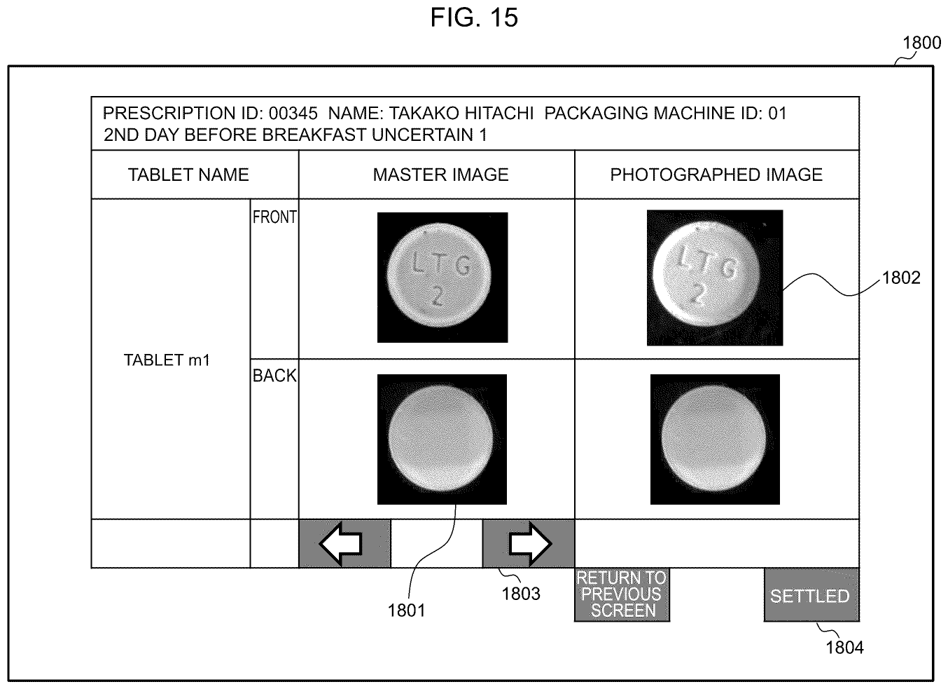

The inspection process screen 1600 displays the tablet images photographed by the drug inspection apparatus 11 in a state of being arranged for the number of days for each individual tablet according to the inspection result of the apparatus, and thereby, the pharmacist can confirm that the wrong tablet is not contained, at a glance. The pharmacist views the inspection process screen 1600, confirms that types and amounts of tablets of all the packaged individual drugs m contained in the drug M1 are correct, then presses the inspection result settlement button 1603, and thereby, can complete the inspection of the drug M1 by the pharmacist. If the pharmacist has determined that the detailed confirmation is necessary for the individual drugs (for example, the tablet m1), it is also possible for the pharmacist to proceed with the pharmacist inspection, by displaying an inspection correction screen of FIG. 15, which will be described later, and visually comparing the display in which the master image of the tablet m1 and the image photographed by the apparatus are arranged side by side.

FIG. 14 is a diagram showing another example of the inspection process screen. The inspection process screen 1700 shown in FIG. 14 is a specific example of the inspection process screen in a case where the drug (tablet) m of “confirmation needed” or “uncertain” is included in the inspection result by the drug inspection apparatus 11 for the drug M2.

The inspection process screen 1700 displays information 1701 such as a prescription ID of the drug M2, a patient name and an inspected packaging machine ID, and displays a list of photographed images of individual drugs (tablets) m contained in the drug M2. This list display is shown in a table format which shows the drug names of the tablets m1 to m3 and the uncertain drugs of which the drug names have not been specified, in each row, and the number of prescription days which have been prescribed, in each column. In addition, the types of the time point dosage are displayed in tabs 1702 to 1704, and by selecting the tabs, the tablet images of the individual tablets m can be displayed for each time point dosage.

In the inspection process screen 1700, the individual tablets m determined as “confirmation needed” in the inspection result by the drug inspection apparatus 11 are highlighted in such a way that the periphery of the display area of the photographed image is colored, or the like (two places of oblique-line hatching 1706 in the figure). In addition, for the individual tablets m determined as “uncertain” in the inspection result by the drug inspection apparatus 11, the photographed images are displayed in the row of “uncertain 1” or “uncertain 2” different from the rows of the individual drug names which are included in the prescription information of the drug M2, but also in this case, the display area of the photographed image may be highlighted by, for example, coloring in the periphery of the display area (in the figure, three places of grid-line hatching 1707). The above display for “confirmation needed” or “uncertain” allows the pharmacist to recognize the individual tablets to be confirmed and corrected, at a glance. Note that the distinguishability can be enhanced by highlighting “confirmation needed” and “uncertain” differently. In addition, the inspection process screen 1700 is provided with a warning field 1705 for displaying the number of sachets or tablets that need confirmation on the screen, and thereby prevents the pharmacist from forgetting or missing the inspection.

FIG. 15 is a diagram showing one example of the inspection correction screen. The inspection correction screen is a screen that is displayed when a photographed image of an arbitrary individual tablet displayed in a list is clicked on the inspection process screen shown in FIG. 13, and FIG. 14, and an inspection correction screen 1800 shown in FIG. 15 is a specific example thereof.

The inspection correction screen 1800 is configured mainly by display fields of two rows and three columns. Specifically, the name of the tablet (tablet m1 in FIG. 15) which has been allocated as the identification result by the drug inspection apparatus 11 (imaging and inspection processing portion 803) is displayed in the first column on the left side of the screen, and the master image 1801 of the tablet is displayed in the second column on the right side thereof. For information, the allocation of the above tablet name has been determined specifically in such a way that the imaging and inspection processing portion 803 identifies the photographed image of each drug m which has been extracted from the photographed image of the drug M by the inspection imaging portion 500, compares the identification result with the drug prescription data and the drug master data (or the drug database 904), thereby determines the corresponding master tablet, and allocates the tablet name of the master tablet. Furthermore, in the inspection correction screen 1800, an enlarged image 1802 of the individual drug (in this case, the tablet m1) which has been photographed by the drug inspection apparatus 11 (inspection imaging portion 500) is displayed in the third column on the right side of the screen. For information, as for the image displays of the second column and the third column, the images of the front surfaces are displayed in the first row on the upper side, and the images of the rear surfaces are displayed in the second row on the lower side.

The pharmacist views the inspection correction screen 1800, visually confirms that the master image 1801 and the photographed image (enlarged image 1802) of the tablet of the target, which is determined as “confirmation needed”, are the same type of individual tablet, then presses the settlement button 1804, and settles the inspection result. When the inspection result is settled by depression of the settlement button 1804, the highlighted display of the target tablet disappears which has been set as “confirmation needed”, for example, on the inspection process screen 1700 of FIG. 14. For information, in the photographed images displayed on the inspection process screens 1600 and 1700 of FIG. 13 and FIG. 14, only images of surfaces are displayed which have the engraved mark or a print and can be visually distinguished from other tablets, but the inspection correction screen 1800 displays photographed images of both the front and back surfaces of the tablet, in order to confirm detailed information of the individual tablet m.

For information, the inspection correction screen 1800 of FIG. 15 is an inspection correction screen that is displayed in the case where the tablet m1 (hatching 1706) of the third day has been selected, which has been displayed as “confirmation needed” on the inspection process screen 1700 of FIG. 14, but also in the case where the tablet (hatching 1707) which has been shown as “uncertain” has been selected on the inspection process screen 1700, the tablet can be similarly corrected with the use of the inspection correction screen 1800 of FIG. 15.

In the case of individual tablets of “uncertain”, there is not a master tablet that has been allocated as the identification result by the drug inspection apparatus 11 (the imaging and inspection processing portion 803), accordingly, a master tablet which is not allocated among the individual tablets contained in the drug M2 is preferentially selected, and the tablet name and the master image thereof are displayed, as names in the first column and the second column of the inspection correction screen 1800. For information, the display of the master image 1801 and the like can be switched to another candidate of the master tablet included in the prescription information of the drug M2, by an operation of pressing an arrow button 1803 provided at the lower part of the display field of the master image 1801.

The pharmacist views the inspection correction screen 1800, visually confirms that the master image 1801 and the photographed image (enlarged image 1802) of the uncertain tablet are the same type of individual tablet for the tablet of the target, which has been determined as “uncertain”, then presses the settlement button 1804, and settles the inspection result. When the inspection result is settled by the depression of the settlement button 1804, the image of the tablet of the target, which has been displayed as “uncertain” on the inspection process screen 1700 is corrected so as to be displayed in the row of the individual tablet m which has been visually confirmed, and the highlighted display of the target tablet disappears.

In addition, the pharmacist may not use the inspection correction screen 1800 as in the above way, but can perform an operation of dragging and dropping the image of the tablet which has been determined as “uncertain” to the row of the correct individual tablet on the inspection process screen 1700, and can also correct the inspection result.

Then, when the pharmacist has performed the above procedure and completes the visual confirmation and the correction of the inspection result for all the individual tablets for which the inspection result is “confirmation needed” or “uncertain”, the pharmacist presses the inspection result settlement button 1708 on the inspection process screen 1700, and completes the pharmacist inspection for the drug M2. As a result, the display of the inspection process screen 1700 ends, and the display returns to the initial screen of the inspection selection 1500 shown in FIG. 15.

Note that the present invention is not limited to the above Examples, and includes various modified examples. Various modified plans can be considered for the configuration and control method of the drug inspection apparatus 11, depending on the conditions such as the number and shape of the drug M, and the conditions of the inspection work for the prescription drug of the pharmacist.

For example, as for the conditions of the number and shape of the drugs M, in the case where the number is one, or in the case where the drug having the same spherical shape is naturally spread out, the drug inspection apparatus 11 may not include the pre-inspection storage portion 200 and the transfer processing portion 300, but can also directly drop the drug M which has been received, onto the circumference mounting plate 402 of the rotary disc 401 of the conveyance inspection processing portion 400.

In addition, for example, in the case where the inspection process is not needed though depending on the drug, it is also possible to add a mechanism which can move the drug directly to the post-inspection storage portion 700 without passing the drug through the conveyance inspection processing portion 400, after the pre-inspection storage portion 200 has received the drug.

In addition, for example, in the description of FIG. 7 and the like, the circumference mounting plate 402 of the rotary disc 401 in the conveyance inspection processing portion 400 is configured to be divided into four quadrants. However, it is also acceptable to divide the plate into six to ten quadrants or the like, if the number of the drugs M is small; or for simplification, to reduce the number of quadrants to be divided, or not to divide the plate into quadrants.

On the other hand, in the case where it is difficult to inspect individual drugs, as in the case where the number of drugs M is large (for example, 10 or more) or a large drug is contained, the whole inspection processing portion 801 may also be configured so as to grasp the type and amounts of tablets which the drug inspection apparatus 11 receives from the host apparatus, on the basis of the drug prescription data, and variably handle the host apparatus, charging timing of the drug, and the cycle and number of times of the repetitive operation. For example, in the case of the drug inspection apparatus 11, there is also the case where the capacity of the pre-inspection storage portion 200, the conveyance inspection processing portion 400 or the like for storing the drug is determined in advance, and the drug described in the drug prescription data cannot be charged into the drug inspection apparatus 11 at one time. In such a case, it is possible to adjust the processing method by a method of dividing the number of times of the drug charging, into two or more times, by the adjustment with the host apparatus, and processing the drugs with the use of a plurality of sections in the rotary disc 401. In addition, some drugs have a characteristic of being easily overlapped, depending on the shape and combination of the drugs; and in the case, the drugs can also be adjusted so as to be separately charged into the drug inspection apparatus 11.

In addition, in order to enhance an inspection performance for the drug, the drug inspection apparatus may be configured, in the case where the drug inspection apparatus has failed in the drug inspection, so as not to discharge the drug from the rotary disc 401, but hold the drug on the rotary disc 401 for another round, take the picture again, and pass the drug for the inspection.

According to the Example 1 or the modified example thereof as in the above, there are provided the drug inspection apparatus and the drug inspection method each having the following features (1) to (4).
(1) Even in the case where the drug M is a combination of a large number of drugs having different shapes, for example, contains ten types of tablets having different shapes, the drug inspection apparatus transfers the individual drugs in a longitudinal row (substantially one row along the conveyance path) in the elongated conveyance space and in a non-overlapping state (spread state); and thereby can reliably take images of the upper and lower surfaces of the individual drugs, and can acquire a high-definition image. Thus, there can be provided the drug inspection apparatus and the drug inspection method which can execute the inspection with high accuracy or high probability.
(2) Even in the case where the drug M is a combination of a large number of drugs having different shapes, the drug inspection apparatus transfers the drug M to the elongated conveyance space on the rotary disc, divides the drug into individual drugs from the images in which the plurality of drugs have been imaged while being conveyed at a constant speed, and inspects the drugs; thereby can narrow the field of view of the installed camera, and accordingly facilitates the inspection process (image cutout) to be miniaturized and to be performed at higher speed. Thus, there can be provided the drug inspection apparatus which is compact and can perform the process at high speed, and the drug inspection method.
(3) Even in the case where the drug M is a combination of a large number of drugs having different shapes, the drug inspection apparatus rotates the elongated conveyance space on the rotary disc by about 360 degrees, and performs the inspection process; and thereby can clearly distinguish the preceding drug from the following drug, by a series of operations in one direction, without needing a reciprocating operation. Thus, there can be provided the drug inspection apparatus which is suitable for processing a plurality of continuous drugs, and the drug inspection method.
(4) The drug inspection apparatus rotates the elongated conveyance space on the horizontal rotary disc by about 360 degrees and performs the inspection process, and thereby can arrange the pre-inspection storage portion and the post-inspection storage portion in the vicinity of each other with a small height difference; and accordingly, there can be provided a miniaturized drug inspection apparatus in which a height dimension is small, and a drug charged portion and a drug discharged portion exist in the vicinity.

### Example 2

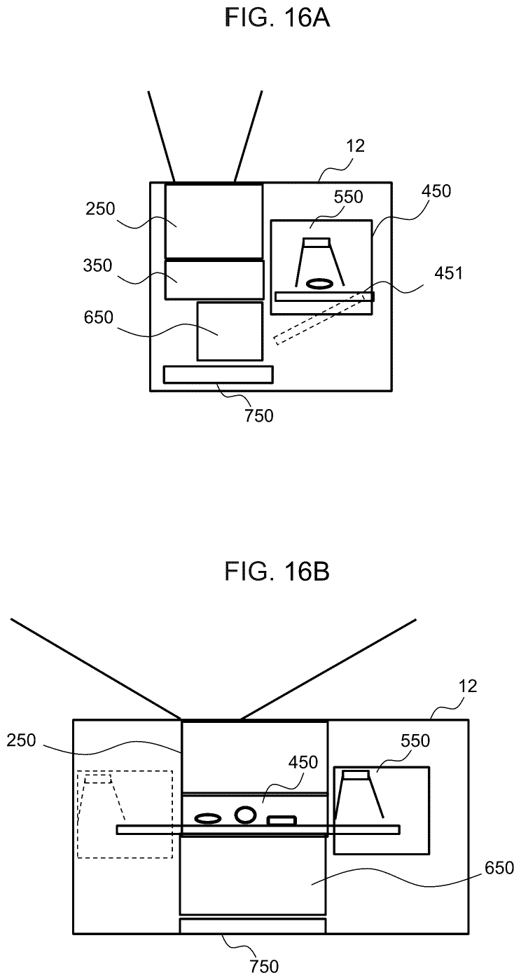

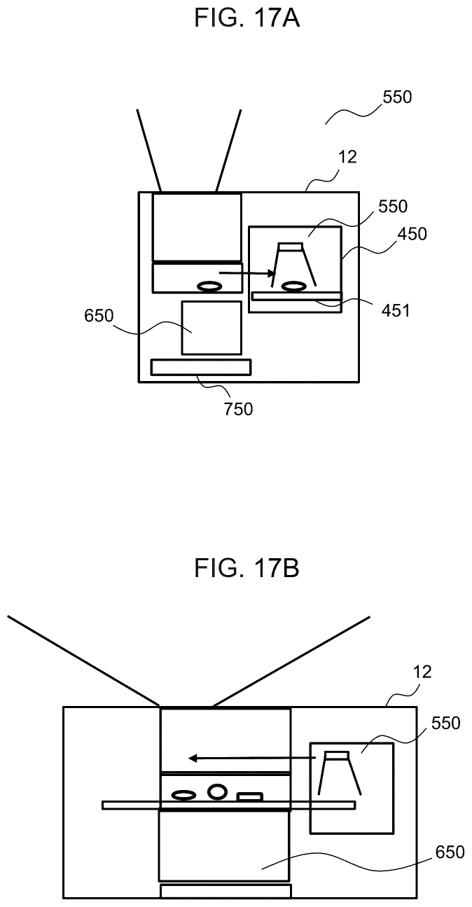

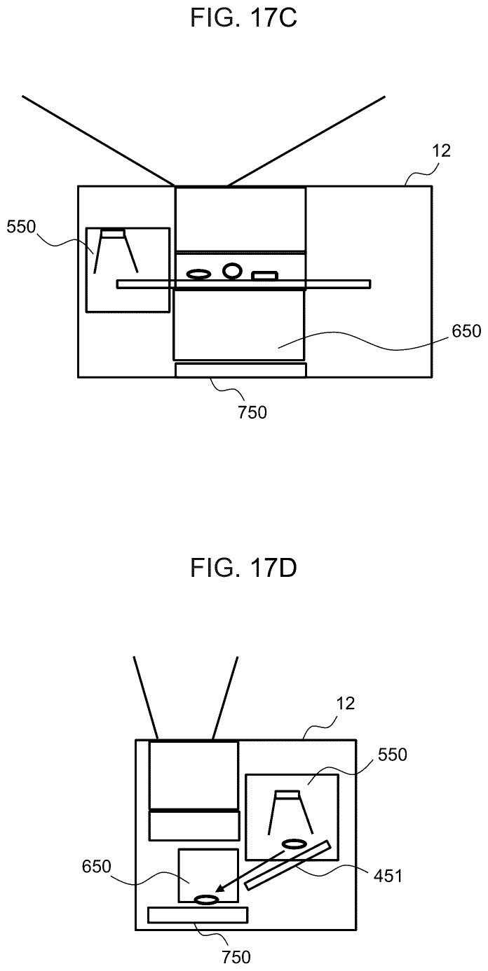

The drug inspection apparatus 11 of the previously described Example 1 has adopted a rotary disc in the conveyance inspection processing portion 400 having the inspection imaging portion 500, and thereby has had such an advantage of being capable of continuously and stably performing a high-speed process from the charge to discharge of the drug, by one rotation operation. On the other hand, the drug inspection apparatus 11 of the Example 1 has had a problem that the apparatus is upsized to some extent. Then, in Example 2, as one example of the drug inspection apparatus 10 in which miniaturization is prioritized, the drug inspection apparatus 12 will be described with reference to FIG. 16A, FIG. 16B, and FIG. 17A to FIG. 17D.

FIG. 16A is a side view of the drug inspection apparatus 12 according to the Example 2, and FIG. 16B is a front view of the drug inspection apparatus 12 according to the Example 2. In addition, FIG. 17A to FIG. 17D are views (Part 1 to Part 4) for describing the operation of the drug inspection in the drug inspection apparatus 12. The FIG. 17A to FIG. 17D show the movement of the drug M in the drug inspection, in time series. FIG. 17A and FIG. 17D are side views, and FIG. 17B and FIG. 17C are front views.

The drug inspection apparatus 12 is configured to include a pre-inspection storage portion 250, a transfer processing portion 350, a conveyance inspection processing portion 450, an inspection imaging portion 550, a discharge processing portion 650, a post-inspection storage portion 750, and an unillustrated inspection control portion. As in the Example 1, the outline of the function of each component corresponds to the function of the component having the same name in the drug inspection apparatus 10. In addition, in the following description, the description of the configuration and the control operation which are common to those of the Example 1 will be omitted.

As shown in FIG. 16A and FIG. 16B, in the drug inspection apparatus 12, the pre-inspection storage portion 250 and the transfer processing portion 350 are continuously arranged in the vertical direction, and have the same configurations and perform the same control operations as the pre-inspection storage portion 200 and the transfer processing portion 300 of the drug inspection apparatus 11. Specifically, the drug M which has been charged into the pre-inspection storage portion 250 is pushed out from the transfer processing portion 350 to the conveyance inspection processing portion 450. A flat plate 451 is arranged in the conveyance inspection processing portion 450, and the drug M which has been pushed out from the transfer processing portion 350 is held on the flat plate 451 (see FIG. 17A). A point at which the conveyance inspection processing portion 450 of the present Example is different from the conveyance inspection processing portion 400 of the Example 1 includes that the conveyance inspection processing portion 450 does not have a moving conveyance path (the rotary disc 401). In other words, the conveyance inspection processing portion 450 holds the drug M which has been transferred from the transfer processing portion 300 onto the flat plate 451, without moving the drug M, until the drug M is discharged to the discharge processing portion 650 by the operation of the flat plate 451, as will be described later.

The inspection imaging portion 550 includes an upper camera which is arranged on the flat plate 451. After the conveyance inspection processing portion 450 has held the drug M on the flat plates 451, the inspection imaging portion 550 is moved horizontally by an unillustrated driving means to a position which is indicated by a dotted line in FIG. 16B, and images the drug M (see FIG. 17B and FIG. 17C). The flat plate 451 is configured to be movable to an inclined state which is shown by a dotted line in FIG. 16A, and after the inspection imaging portion 550 has taken an image of the drug M, the flat plate 451 operates to the inclined state; and thereby, the drug M passes through the discharge processing portion 650, moves to the post-inspection storage portion 750, and is then discharged (see FIG. 17D). The configurations and control operations of the discharge processing portion 650 and the post-inspection storage portion 750 are the same as those of the discharge processing portion 600 and the post-inspection storage portion 700 of the drug inspection apparatus 11.

For information, in the drug inspection apparatus 12 shown in FIG. 16A, FIG. 16B, and FIG. 17A to FIG. 17D, the inspection imaging portion 550 has been described to include only the upper camera, in order to prioritize the miniaturization, but may be configured to include a lower camera as well, and to be capable of taking pictures of the drug M from above and below, similarly to that in Example 1.

According to the Example 2 as in the above, even in the case where the drug M is a combination of a large number of drugs having different shapes, for example, contains ten types of tablets having different shapes, the drug inspection apparatus transfers the individual drugs in a longitudinal row (substantially one row along the conveyance path) in the elongated conveyance space which is similar to that in the Example 1, and in a non-overlapping state (spread state); and thereby can acquire a high-definition image. Thus, there can be provided a drug inspection apparatus which is small-sized and can execute the inspection with high accuracy or high probability.

For information, the drug inspection apparatus 12 of the Example 2, the substantial configuration of the conveyance inspection processing portion 450 is only the flat plate 451 serving as a mounting plane for the drug M and the space in the vicinity thereof, and accordingly, these plane and space may be configured as, for example, one configuration of the discharge processing portion 650, without being configured to be the conveyance inspection processing portion 450. When being configured in this way, the drug inspection apparatus 12 does not need to include the conveyance inspection processing portion 450.

In addition, in the Example 2, in order to process a plurality of consecutive drugs M at a high speed, it is also acceptable to configure not only the mechanism for moving the drug but also the inspection imaging portion 550 to be moved at a high speed.

In addition, the Examples described above are each described in detail for the purpose of describing the present invention in an easy-to-understand way, and are not necessarily limited to a configuration including all the configurations described above. In addition, it is also possible to replace a part of a configuration of a certain Example with a configuration of another Example, and it is also possible to add a configuration of another Example to a configuration of a certain Example. In addition, another configuration can be added to, deleted from or replaced with, a part of the configuration of each Example. A part or all of the above configurations, functions, processing portions, processing means and the like may be realized by hardware by, for example, a method of designing them in an integrated circuit or the like. In addition, the above configurations, functions and the like may be realized by software, by a processor which interprets and executes a program for implementing the respective functions. In addition, information such as programs, tables, files and the like for realizing the respective configurations can be stored in a recording apparatus such as a memory, a hard disk or an SSD (Solid State Drive), or a recording medium such as an IC card, an SD card or a DVD.

### REFERENCE SIGNS LIST

10, 11, 12 drug inspection apparatus
20 pre-inspection storage portion
30 transfer processing portion
40 conveyance inspection processing portion
50 inspection imaging portion
60 discharge processing portion
70 post-inspection storage portion
80 inspection control portion
101 drug packaging apparatus
102 drug storage portion
103 drug supply portion
104 drug packaging portion
105 packaged drug
106 individual drug
107 one package prescription drug
200, 250 pre-inspection storage portion
201 charge vibration alignment portion
202 charge partition plate
203 storage case
204, 205 arrow
206 rotary shaft
300, 350 transfer processing portion
301 transfer guide
302 transfer push-out plate
303 transfer push-out alignment portion
304 transfer portion shutter
400, 450 conveyance inspection processing portion
401 rotary disc
402 circumference mounting plate
403 inner circumferential guide
404 circumference partition plate
405 outer circumferential guide
406 support frame
451 flat plate
500, 550 inspection imaging portion
501 camera
501A upper camera
501B lower camera
502, 502A, 502B illumination lamp (reflection illumination)
515 transmission illumination
516 semi-transmission sheet
521 backlight image
522 forward light image
600 discharge processing portion
601 discharge guide
602 discharge lever
700 post-inspection storage portion
702 discharge partition plate
800 inspection control portion
801 whole inspection processing portion
802 inspection result processing portion
803 imaging and inspection processing portion
804 drug operation control portion
805 drug operation portion
901 inspection result display screen
902 host prescribed-drug instruction apparatus
903 server
904 drug database
1500 initial screen of inspection selection
1600, 1700 inspection process screen

1. A drug inspection apparatus that inspects dispensed drugs, comprising:
a pre-inspection storage portion that temporarily stores a drug group which is a plurality of drugs collectively charged, and spreads individual drugs in an elongated and substantially one row;
a transfer processing portion that transfers the drug group to a conveyance path while maintaining a spread state in the pre-inspection storage portion;
a conveyance inspection processing portion that conveys the drug group transferred to the conveyance path at a predetermined speed, and also has an inspection imaging portion that takes images of individual drugs of the drug group on the conveyance path;
a discharge processing portion that discharges the imaged drug group to a post-inspection storage portion;
the post-inspection storage portion that temporarily stores the drug group discharged by the discharge processing portion, and then discharges the drug group to the outside of the apparatus; and
an inspection control portion that executes, by software control, a control of operations of the pre-inspection storage portion, the transfer processing portion, the conveyance inspection processing portion, the discharge processing portion and the post-inspection storage portion, and an inspection process for the drug group, which uses a captured image by the inspection imaging portion, wherein
the inspection control portion performs image identification of the captured image of the drug group by the inspection imaging portion with the use of master data of a plurality of types of drugs that have been registered in advance, in the inspection process for the drug group, thereby identifies the type and the number of the imaged individual drugs, inspects whether or not the identified content matches the constitution of the drugs shown in the prescription data of the drug group, and notifies an inspection result.

2. The drug inspection apparatus according to claim 1, wherein
the pre-inspection storage portion forms a storage space for the drug group so that an inclined surface is V-shaped and a bottom surface is elongated, and causes the individual drugs of the drug group to be spread in an elongated and substantially one row on the bottom surface by vibrating a constituent member of the inclined surface, and
the transfer processing portion transfers the drug group to the conveyance path along a direction in which the drug group is conveyed on the conveyance path.

3. The drug inspection apparatus according to claim 1, wherein
the conveyance inspection processing portion has a section structure capable of dividing the drug groups continuously charged into a predetermined number in a charged order and conveying the drug groups; and
when a plurality of the drug groups are continuously charged,
the inspection control portion executes the inspection process for a previously charged drug group and the inspection process for a subsequently charged drug group in parallel, at different start timings.

4. The drug inspection apparatus according to claim 3, wherein
the conveyance inspection processing portion has a rotary disc that rotates as the conveyance path, and drug mounting areas which are obtained by division of the rotary disc into N parts with a predetermined width of an outer circumference in a rotation direction, as the section structure; and
when the drug mounting area which mounts the drug group thereon passes through a predetermined range, by the rotation of the rotary disc, the inspection imaging portion takes a picture of the drug mounting area.

5. The drug inspection apparatus according to claim 1, wherein
the conveyance path is formed from a transparent material; and
the inspection imaging portion has an upper camera that is installed on an upper side of the conveyance path, and takes images of the individual drugs on the conveyance path, from the upper side, and a lower camera that is installed on a lower side of the conveyance path at a position shifted from an installation position of the upper camera by a predetermined amount in the conveyance direction, and takes images of individual drugs on the conveyance path, from the lower side, with light transmitted through the conveyance path.

6. The drug inspection apparatus according to claim 1, wherein
the inspection imaging portion has reflection illumination that is installed on the same side as the camera when viewed from the conveyance path, and illuminates individual drugs on the conveyance path from an oblique side surface.

7. The drug inspection apparatus according to claim 6, wherein
the conveyance path is formed from a transparent material; and
the inspection imaging portion has transmission illumination that is installed on a side opposite to the camera when viewed from the conveyance path, with respect to the camera 1, in addition to the reflection illumination, and illuminates individual drugs on the conveyance path from a back surface side, with light transmitted through the conveyance path; and
in the photographing by the camera, performs first photographing for acquiring a forward light image in which a surface of the individual drug has been imaged, by taking a picture of the conveyance path in a state in which the reflection illumination is turned on and the transmission illumination is turned off, and performs second photographing for acquiring a backlight image in which an outer shape of the individual drug has been imaged, by taking a picture of the conveyance path in a state in which the reflection illumination is turned off and the transmission illumination is turned on.

8. The drug inspection apparatus according to claim 7, wherein
the inspection imaging portion has a semi-transmission sheet that is arranged between the transmission illumination and the conveyance path, and does not reflect illuminated light by the reflection illumination, and transmits illuminated light by the transmission illumination.

9. The drug inspection apparatus according to claim 7, wherein
the inspection imaging portion alternately, periodically and continuously performs the first photographing and the second photographing, in the photographing by the camera.

10. The drug inspection apparatus according to claim 1, wherein
the post-inspection storage portion has a storage portion camera that takes an image of a storage space of the post-inspection storage portion; and
the post-inspection storage portion performs an operation of discharging the drug group to the outside of the apparatus, then takes an image of the storage space by the storage portion camera, and confirms that all the drugs constituting the drug group have been discharged, on the basis of the captured image.

11. The drug inspection apparatus according to claim 1, wherein
the inspection control portion can display at least one of an initial screen of inspection selection, which displays an implementation state of the inspection process for the drug group and an inspection result of the inspection process,
an inspection process screen that displays detailed information concerning an inspection result of the inspection process, and
an inspection correction screen that can receive correction by a user, for a drug that does not match a drug which is indicated in the prescription data of the drug group among drugs which have been identified from the captured image in the inspection process, according to the inspection situation.

12. The drug inspection apparatus according to claim 11, wherein
the inspection control portion configures the inspection correction screen so that the user can select and settle the type of the drug from the drugs registered in the master data, when the type of the drug which has been identified from the captured image in the inspection process cannot be specified, and displays the inspection correction screen.

13. A drug inspection apparatus that inspects dispensed drugs, comprising:
a pre-inspection storage portion that temporarily stores a drug group which is a plurality of drugs collectively charged, and spreads the individual drugs in an elongated and substantially one row;
a transfer processing portion that transfers the drug group to a predetermined mounting plane while maintaining a spread state in the pre-inspection storage portion;
an inspection imaging portion that takes images of individual drugs of the drug group, which are transferred to the predetermined mounting plane, by a camera movable above the predetermined mounting plane;
a discharge processing portion that is arranged below the predetermined mounting plane, and discharges the drug group after having been imaged to a post-inspection storage portion from the predetermined mounting plane;
the post-inspection storage portion that temporarily stores the drug group discharged by the discharge processing portion, and then discharges the drug group to the outside of the apparatus; and
an inspection control portion that performs an inspection process for the drug group with the use of the captured image by the inspection imaging portion, wherein
the pre-inspection storage portion forms a storage space for the drug group so that an inclined surface is V-shaped and a bottom surface is elongated, and causes the individual drugs of the drug group to be spread in an elongated short row and substantially in one row on the bottom surface, by vibrating a constituent member of the inclined surface;
the predetermined mounting plane has a structure of being inclined downward and opening the front, and thereby dropping the drug group after the imaging to the discharge processing portion; and
the inspection control portion performs image identification of the captured image of the drug group by the inspection imaging portion with the use of master data of a plurality of types of drugs that have been registered in advance, in the inspection process for the drug group, thereby identifies the type and the number of the imaged individual drug, inspects whether or not the identified contents match the constitution of the drug shown in the prescription data of the drug group, and notifies an inspection result.

14. A drug inspection method by a drug inspection apparatus that inspects dispensed drugs, wherein
the drug inspection apparatus comprises:
a pre-inspection storage portion that temporarily stores a drug group which is a plurality of drugs collectively charged, and spreads the individual drugs in an elongated and substantially one row;
a transfer processing portion that transfers the drug group to a conveyance path while maintaining a spread state in the pre-inspection storage portion;
a conveyance inspection processing portion that conveys the drug group transferred to the conveyance path at a predetermined speed, and also has an inspection imaging portion that takes images of individual drugs of the drug group on the conveyance path;
a discharge processing portion that discharges the imaged drug group to a post-inspection storage portion;
the post-inspection storage portion that temporarily stores the drug group discharged by the discharge processing portion, and then discharges the drug group to the outside of the apparatus; and
an inspection control portion that executes, by software control, a control of operations of the pre-inspection storage portion, the transfer processing portion, the conveyance inspection processing portion, the discharge processing portion and the post-inspection storage portion, and an inspection process for the drug group, which uses a captured image by the inspection imaging portion, wherein
the inspection control portion performs image identification of the captured image of the drug group by the inspection imaging portion with the use of master data of a plurality of types of drugs that have been registered in advance, in the inspection process for the drug group, thereby identifies the type and the number of the imaged individual drugs, inspects whether or not the identified content matches the constitution of the drugs shown in the prescription data of the drug group, and notifies an inspection result.
